(19) United States
(12) Patent Application Publication
(10) Pub. No.: US 2009/0199666 A1
(43) Pub. Date: Aug. 13, 2009

(54) Transmission Gearbox Family in Parallel Shaft Transmission System

(76) Inventors: Ching-Min Yang, Beijing (CN); Jian-Gang Lu, Datong (CN); Daming Wang, Beijing (CN); Guojun Shi, Canton, MI (US)

Correspondence Address: Guojun Shi, 49016 Manhattan Cir., Canton, MI, 48188, US

(21) Appl. No.: 12/030,175

(22) Filed: Feb. 12, 2008

(51) Int. Cl. F16H 3/08; F16H 3/093

(52) U.S. Cl. 74/331; 74/333

(57) ABSTRACT

This invention relates to a transmission gearbox family to provide five, six, seven, eight and nine speed ratios with a reverse speed ratio and a neutral condition in motor vehicles. The invention arranges a plurality of gearwheels in parallel shaft systems such that minimum number of gearwheels is obtained by either combination of clutches with synchronizers for transmission gearboxes with a torque converter and direct clutch to clutch gearboxes without a torque converter, or synchronizers for automated manual transmission gearboxes. For total number of the gearwheels involving in forward driving, five-speed transmission gearboxes have eight gearwheels, six-speed transmission gearboxes have minimum of nine gearwheels, seven-speed transmission gearboxes have minimum of nine gearwheels, eight-speed transmission gearboxes have minimum of nine gearwheels and nine-speed transmission gearboxes have minimum of nine gearwheels, respectively. Each family member has three parallel shafts with either selectively or continuously interconnected with the gearwheels through the engaged single or multiple torque transmitting mechanisms. The direct clutch-to-clutch gearboxes without a torque converter and automated manual gearboxes have a mechanical damper and a main clutch.

### CROSS-REFERENCE TO RELATED APPLICATIONS

| | | |
|---|---|---|
| 7,305,900 | Dec. 10, 2007 | Suzuki, et al. |
| 7,294,091 | Nov. 13, 2007 | Yasui, et al. |
| 7,082,850 | Aug. 1, 2006 | Hughes, et al. |
| 6,715,597 | Apr. 6, 2004 | Buchanan, et al. |
| 6,705,967 | Mar. 16, 2004 | Raghavan, et al. |
| 6,656,078 | Dec. 2, 2003 | Raghavan, et al. |
| 6,463,821 | Oct. 15, 2002 | Reed, Jr., et al. |
| 5,950,781 | Sep. 14, 1999 | Adamis, et al. |
| 5,106,352 | Apr. 21, 1992 | Lepelletier |

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

A powertrain system used in a passenger vehicle is comprised of an engine, multi-speed transmission and a differential or final drive system. The premier function of transmission is to extend the operating range of the vehicle by allowing the engine to perform in the torque range several times higher than the engine torque as the transmission ratio increases and also allows the engine to perform in the output speed range higher than engine speed as transmission ratio reduces, such as in the overdrive speed.

With advent of five and six speed automatic transmissions (U.S. Pat. Nos. 5,106,352 and 6,656,078), the step size between ratios is reduced and the shift quality of the transmission by making the ratio interchanges is substantially improved comparing with three and four speed transmissions. Multi-speed transmissions, such as five and six speed automatic transmissions, also have advantages over fewer speed transmissions, such as three and four speed automatic transmissions, to achieve desirable fuel economy.

Such multi-speed transmissions still use the conventional torque converter for comfort shifting, but have quite low mechanical efficiency. Torque converters typically include impeller assemblies that are operatively connected with input shaft from an internal combustion engine, a turbine assembly that is fluidly connected with the impeller assembly and a stator or reactor assembly. These assemblies together form a substantially toroidal flow passage for kinetic fluid in the torque converter. Each assembly includes a plurality of blades or vanes that act to convert mechanical energy to hydrokinetic energy and back to mechanical energy.

The stator assembly of a conventional torque converter is locked against rotation in one direction but is free to spin about an axis in the direction of rotation of the impeller assembly and turbine assembly. When the stator assembly is locked against rotation by a so-called one-way clutch, the torque is multiplied by the torque converter. During torque multiplication, the output torque is greater than the input torque for the torque converter. On the other hand, when there is no torque multiplication, the torque converter becomes a fluid coupling. Torque converter slip exists when the speed ratio is less than 1.0. The inherent slip reduces the efficiency of the torque converter. Although lock-up device is usually equipped in newly developed transmissions, only a few gears can be locked up to avoid energy loss and the lock-up usually is not complete because partial slippery still exists to prevent the noise and vibration. Therefore, its overall efficiency is still low as long as the torque converter is used and the torque converter is considered as a big technical barrier to efficiency improvement.

Automated manual transmission (AMT), another type of automatic shifting transmission used in motor vehicles, improves the efficiency by removing the torque converter. Such automated manual transmissions typically include a plurality of power-operated actuators that are controlled by a transmission controller or some type of electronic control unit (ECU) to automatically shift synchronized clutches that control the engagement of meshed gearwheels traditionally found in manual transmissions. It does the function of interchanging the speed ratio by automatically disengaging the clutch disc, choosing the right gear ratio, shifting to the gear and engaging clutch automatically. Although this shifting procedure causes discontinuous torque delivery and harsh shift feel to passengers, it still has been used in some of the motor vehicles, since the efficiency can be as good as manual transmissions.

The transmission using twin-clutch, known as dual-clutch transmission (U.S. Pat. Nos. 5,950,781 and 6,463,821), also removes the torque converter to improve the mechanical efficiency. The dual clutch structure has two coaxially and cooperatively configured clutches that derive power input from a singular engine crankshaft. It consists of two independent transmission systems that have two concentric driving shafts, one is hollow and the other is solid within the hollow shaft. The first, third and fifth driving gears are on one of the driving shafts and the second, forth and sixth gears are on the other shaft. The third shaft is a driven shaft that has all the driven gears on it. The gear shifting operation is activated by dogs and sliding sleeves on driving and driven shafts. When a gear is shifted to the next gear for ratio interchange, it engages one of the clutches while the other is still in engagement. Due to the two-clutch engagement at the same time, one of them or both of them must create relative slip motion to prevent gearwheel from damages while the output speed takes the transition for a gradual change to the next gear. The shifting operation can provide comfort feel that is similar to the one by using a torque converter. The dual-clutch transmission soon receives increasing popularity in the applications of passenger cars. However, the clutch assembly working within the dual-clutch transmission generates a considerable amount of heat (U.S. Pat. No. 6,715,597). Especially, when the vehicle starts to launch and heavily loaded, the high pressure acts on the clutch discs while slip is required for smooth transition (U.S. Pat. No. 6,463,821). The slip in dual clutch is quite high compared to that in conventional automatic transmissions where the clutch slip is limited between driving and driven clutch discs. These conventional automatic transmissions, either using planetary gear sets or parallel shafts with external gear sets, usually have an uncontrolled way to dissipate the heat that is generated from torque converter, clutches, gears and actuators, etc., by using a transmission fluid cooler. It has been proven to be reliable and economic for long time operations through the reduced pump pressure to circulate the flow. However, in the dual-clutch transmission, since more heat can be generated in a short period of time, this cooling method is insufficient to maintain the required fluid temperature. The requirements to the materials in friction elements are, hence, higher, and the way to cool down the transmission fluid and its control procedures are much more complicated (U.S. Pat. No. 6,715,597). Although dual-clutch transmission provides high mechanical efficiency and shifting quality, it can only be used in limited types of lighter duty vehicles due to these disadvantages.

The above mentioned transmission systems have to be packaged in the limited space provided by under hood compartment in a motor vehicle. In a planetary gear system, six, seven and eight speed transmissions are invented to use only three planetary gear sets. Dual-clutch transmission systems contain only twelve forward external driving gearwheels. A technique to reduce shaft center distance and number of gearwheels is to repeatedly use gear sets by interlocking the tow input shafts. However, the drawbacks of this technique are the need to install additional damper in the large diameter gearwheel and the introduction of bending moment to engine crankshaft (U.S. Pat. No. 7,305,900).

### BRIEF SUMMARY OF THE INVENTION

One of the objectives of the present invention is to introduce a new transmission family by using the gearwheels as minimum numbers as possible to achieve the full range of the gear ratios which overcomes the disadvantages in automatic transmissions, automated manual transmissions (AMT) and dual-clutch transmissions (DCT) which typically require more gearwheels. The virtue of this invention is to obtain each selected gear ratio by interconnecting multiple gearwheels and or multiple gear sets simultaneously instead of using one gear set for only one selected gear ratio. Therefore, the total number of gearwheels is reduced to a minimum level, the size of the gearbox is designed to a compact level and the bending moment is limited in a negligible level in such parallel shaft transmission system. Another objective of the present invention is to reduce the relative clutch slippery speed between driving and driven clutch pads and to increase the durability of the transmission by minimizing the heat in the transmission gearboxes that are equipped with hydraulic clutches. Meanwhile, the cost effective material for the clutch pad can be used without compromising the basic cooling requirement and the longevity of the gearbox.

In one aspect of the present invention, the transmission gearbox comprises three parallel shafts and multiple external gear sets. Each of the external gear sets consists of external gearwheels which are selectively interconnected to each of the mentioned three parallel shafts for the forward driving speeds. In another aspect of the present invention, the external gear sets contain the continuously interconnected gearwheels which reduce the center distance between the parallel shafts whenever it becomes necessary.

In yet another aspect of the present invention, each of the external gear sets is selectively controlled by torque transmitting mechanisms to produce at least five forward speed ratios and one reverse ratio. Herein, the torque transmitting mechanisms consist of clutches and synchronizers.

In still yet another aspect of the present invention, in the five-speed transmission gearboxes, six of eight gearwheels are used for more than one forward speed ratio. In yet a further aspect of the present invention, in the six-speed transmission gearboxes with ten forward driving gearwheels, nine of ten gearwheels are used for more than one forward speed ratio. In yet a further aspect of the present invention, in the six-speed transmission gearboxes with eleven forward driving gearwheels, ten of eleven gearwheels are used for more than one forward speed ratio. In yet a further aspect of the present invention, in the six-speed transmission gearboxes with nine forward driving gearwheels, nine of nine gearwheels are used for more than one forward speed ratio. In yet a further aspect of the present invention, in seven-speed, eight-speed and nine-speed transmission gearboxes, nine of nine gearwheels are used for more than one forward speed ratio. These features give the maximum reduction of the total number of gearwheels.

The present invention is embodied in a family of transmission gearboxes that utilize the minimum numbers of forward driving gearwheels to obtain the multiple gear speed ratios in the selected five, six, seven, eight and nine speed gear ratios, which provide a significantly low cost for massive production. In further description, five forward speeds are achieved by selectively interconnecting a minimum of the eight forward speed gearwheels of the five-speed transmission gearboxes; herewith, six forward speeds are achieved by selectively interconnecting a minimum of nine forward speed gearwheels of the six-speed transmission gearboxes; herewith, seven forward speeds are achieved by selectively interconnecting a minimum of nine forward speed gearwheels of the seven-speed transmission gearboxes; herewith, eight forward speeds are achieved by selectively interconnecting a minimum of nine forward speed gearwheels of the eight-speed transmission gearboxes and herewith, nine forward speeds are also achieved by selectively interconnecting a minimum of nine forward speed gearwheels of the transmission gearboxes.

Another embodiment of the present invention is to provide a new type of direct clutch-to-clutch transmission gearboxes, which is operated at a lower clutch slippery speed with more reliable and lower heat generation than a dual-clutch transmission gearbox.

### BRIEF DESCRIPTION OF THE SEVERAL VIEWS OF THE DRAWING(S)

FIG. 1 is a schematic diagram of a five-speed direct clutch-to-clutch transmission gearbox using eight forward driving gearwheels with clutches and synchronizers

FIG. 2 is a truth table of shift sequence of the transmission gearbox in FIG. 1 and ratio steps between adjacent drive ratios

FIG. 3 is a schematic diagram of a five-speed transmission gearbox using a torque converter and eight forward driving gearwheels with clutches and synchronizers

FIG. 4 is a truth table of shift sequence of the transmission gearbox in FIG. 3 and ratio steps between adjacent drive ratios

FIG. 5 is a schematic diagram of a five-speed automated manual transmission gearbox using eight forward driving gearwheels with synchronizers

FIG. 6 is a truth table of shift sequence of the transmission gearbox in FIG. 5 and ratio steps between adjacent drive ratios

FIG. 7 is a schematic diagram of a six-speed direct clutch-to-clutch transmission gearbox using nine forward driving gearwheels with clutches and synchronizers

FIG. 8 is a truth table of shift sequence of the transmission gearbox in FIG. 7 and ratio steps between adjacent drive ratios

FIG. 9 is a schematic diagram of a six-speed transmission gearbox using a torque converter and nine forward driving gearwheels with clutches and synchronizers

FIG. 10 is a truth table of shift sequence of the transmission gearbox in FIG. 9 and ratio steps between adjacent drive ratios

FIG. 11 is a schematic diagram of a six-speed automated manual transmission gearbox using nine forward driving gearwheels with clutches and synchronizers

FIG. 12 is a truth table of shift sequence of the transmission gearbox in FIG. 11 and ratio steps between adjacent drive ratios

FIG. 13 is a schematic diagram of a six-speed direct clutch-to-clutch transmission gearbox using ten forward driving gearwheels with clutches and synchronizers

FIG. 14 is a truth table of shift sequence of the transmission gearbox in FIG. 13 and ratio steps between adjacent drive ratios

FIG. 15 is a schematic diagram of a six-speed transmission gearbox using a torque converter and ten forward driving gearwheels with clutches and synchronizers

FIG. 16 is a truth table of shift sequence of the transmission gearbox in FIG. 15 and ratio steps between adjacent drive ratios

FIG. 17 is a schematic diagram of a six-speed automated manual transmission gearbox using ten forward driving gearwheels with clutches and synchronizers

FIG. 18 is a truth table of shift sequence of the transmission gearbox in FIG. 17 and ratio steps between adjacent drive ratios

FIG. 19 is a schematic diagram of a six-speed direct clutch-to-clutch transmission gearbox using eleven forward driving gearwheels with clutches and synchronizers

FIG. 20 is a truth table of shift sequence of the transmission gearbox in FIG. 19 and ratio steps between adjacent drive ratios

FIG. 21 is a schematic diagram of a six-speed transmission gearbox using a torque converter and eleven forward driving gearwheels with clutches and synchronizers

FIG. 22 is a truth table of shift sequence of the transmission gearbox in FIG. 21 and ratio steps between adjacent drive ratios

FIG. 23 is a schematic diagram of a six-speed automated manual transmission gearbox using eleven forward driving gearwheels with clutches and synchronizers

FIG. 24 is a truth table of shift sequence of the transmission gearbox in FIG. 23 and ratio steps between adjacent drive ratios

FIG. 25 is a schematic diagram of a seven-speed direct clutch-to-clutch transmission gearbox using ten forward driving gearwheels with clutches and synchronizers

FIG. 26 is a truth table of shift sequence of the transmission gearbox in FIG. 25 and ratio steps between adjacent drive ratios

FIG. 27 is a schematic diagram of a seven-speed transmission gearbox using a torque converter and ten forward driving gearwheels with clutches and synchronizers

FIG. 28 is a truth table of shift sequence of the transmission gearbox in FIG. 27 and ratio steps between adjacent drive ratios

FIG. 29 is a schematic diagram of a seven-speed automated manual transmission gearbox using ten forward driving gearwheels with clutches and synchronizers

FIG. 30 is a truth table of shift sequence of the transmission gearbox in FIG. 29 and ratio steps between adjacent drive ratios

FIG. 31 is a schematic diagram of a transmission gearbox for seven-speed, eight-speed and nine-speed transmissions using nine forward driving gearwheels, clutches and synchronizers

FIG. 32 is a truth table of shift sequence of the transmission gearbox in FIG. 31 and ratio steps between adjacent drive ratios for seven speeds

FIG. 33 is a truth table of shift sequence of the transmission gearbox in FIG. 31 and ratio steps between adjacent drive ratios for eight speeds

FIG. 34 is a truth table of shift sequence of the transmission gearbox in FIG. 31 and ratio steps between adjacent drive ratios for nine speeds

FIG. 35 is a schematic diagram of a transmission gearbox for seven-speed, eight-speed and nine-speed automated manual transmissions using nine forward driving gearwheels, a clutch and synchronizers

FIG. 36 is a truth table of shift sequence of the transmission gearbox in FIG. 35 and ratio steps between adjacent drive ratios for seven speeds

FIG. 37 is a truth table of shift sequence of the transmission gearbox in FIG. 35 and ratio steps between adjacent drive ratios for eight speeds

FIG. 38 is a truth table of shift sequence of the transmission gearbox in FIG. 35 and ratio steps between adjacent drive ratios for nine speeds

FIG. 39 is a schematic diagram of transmission gearbox for seven-speed, eight-speed and nine-speed direct clutch-to-clutch transmissions using ten forward driving gearwheels, clutches and synchronizers

FIG. 40 is a truth table of shift sequence of the transmission gearbox in FIG. 39 and ratio steps between adjacent drive ratios for seven speeds

FIG. 41 is a truth table of shift sequence of the transmission gearbox in FIG. 39 and ratio steps between adjacent drive ratios for eight speeds

FIG. 42 is a truth table of shift sequence of the transmission gearbox in FIG. 39 and ratio steps between adjacent drive ratios for nine speeds

FIG. 43 is a schematic diagram of a transmission gearbox for seven-speed, eight-speed and nine-speed automated manual transmissions using ten forward driving gearwheels, a clutch and synchronizers

FIG. 44 is a truth table of shift sequence of the transmission gearbox in FIG. 43 and ratio steps between adjacent drive ratios for seven speeds

FIG. 45 is a truth table of shift sequence of the transmission gearbox in FIG. 43 and ratio steps between adjacent drive ratios for eight speeds

FIG. 46 is a truth table of shift sequence of the transmission gearbox in FIG. 43 and ratio steps between adjacent drive ratios for nine speeds

### DETAILED DESCRIPTION OF THE INVENTION

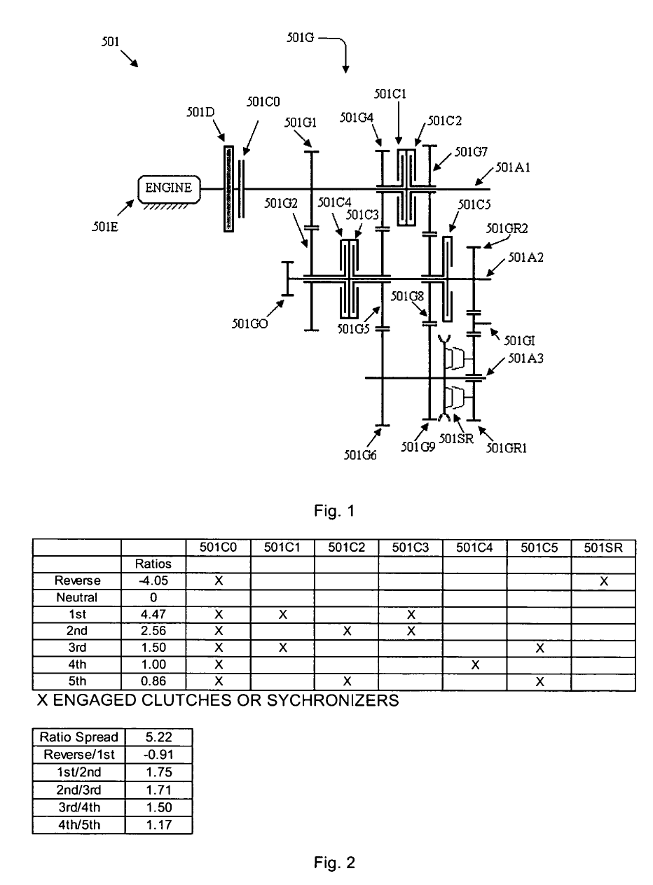

A powertrain system 501, shown in FIG. 1, has a conventional engine 501E and a five-speed transmission gearbox 501G.

The five-speed transmission gearbox 501G includes a mechanical damper 501D, a main clutch 501C0, an input shaft 501A1, an output shaft 501A2 which has a fixed output gearwheel 501GO to transmit torque to a final drive(not shown) and an intermediate shaft 501A3. 501A1 is selectively interconnected with 501C0. 501G also includes a plurality of forward driving gearwheels 501G1, which is fixed on 501A1, 501G2, 501G4, 501G5, 501G6, 501G7, 501G8 and 501G9 which are free to rotate and selectively interconnected with input shaft 501A1, the output shaft 501A2 and the intermediate shaft 501A3 by clutches 501C1, 501C2, 501C3, 501C4 and 501C5, and a synchronizer 501S1, respectively. 501G6 and 501G9 are linked with each other on the intermediate shaft 501A3. 501G also has a reverse driving gearwheel 501GR1 which is free to rotate and selectively interconnected with the intermediate shaft 501A3, a reverse driven gearwheel 501GR2 which is fixed on output shaft 501A2 and 501GI which serves as an idler to change rotating direction. The clutches allow 501G4 and 501G7 to be selectively interconnected with the input shaft 501A1, and 501G2, 501G5 and 501G8 to be selectively interconnected with the output shaft 501A2, respectively. The engagement and disengagement of torque transmitting mechanisms are controlled by conventional electro-hydraulic mechanism, not shown, which includes a programmable digital computer. Such control mechanisms are well known to those skilled in the art.

A static truth table, shown in FIG. 2, gives shift sequence of transmission of FIG. 1 and ratio steps between adjacent drive ratios.

When a forward speed is accomplished, main clutch 501C0 is always engaged. In addition, the following clutch and synchronizer engagements are applied. The first forward speed ratio is established by engagement of clutches 501C1 and 501C3. This results in gearwheel 501G4 driving gearwheel 501G5 to provide first forward speed ratio. The second forward speed ratio is established by engagement of clutches 501C2 and 501C3. This results in 501G7 driving 501G9 through the idler 501G8. Since 501G6 and 501G9 are linked, 501G6 drives 501G5 through the clutch 501C2's engagement to give reduced speed at the output shaft 501A2. The third forward speed ratio is established by engagement of clutches 501C1 and 501C5. This results in 501G4 driving 501G6 through the idler 501G5. Since 501G6 and 501G9 is linked, 501G9 drives 501G8 through the 501C5's engagement to give third reduced speed at the output shaft 501A2. The fourth forward speed ratio is established by engagement of clutches 501C4 only. This results in 501G1 driving 501G2 through the 501C4's engagement to give fourth speed at the output shaft 501A2. The fifth forward speed ratio is established by engagement of clutches 501C2 and 501C5. This results in 501G7 driving 501G8 to give the fifth speed at the output shaft 501A2. The reverse speed ratio is established by the engagements of clutch 501C1 and synchronizer 501SR. This results in 501G4 driving 501G6 through the idler 501G5. Since 501G6 and 501GR1 are linked through engagement of synchronizer 501SR, 501GR1 drives 501GR2 through the idler 501GI to give a reverse speed in reverse direction at the output shaft 501A2.

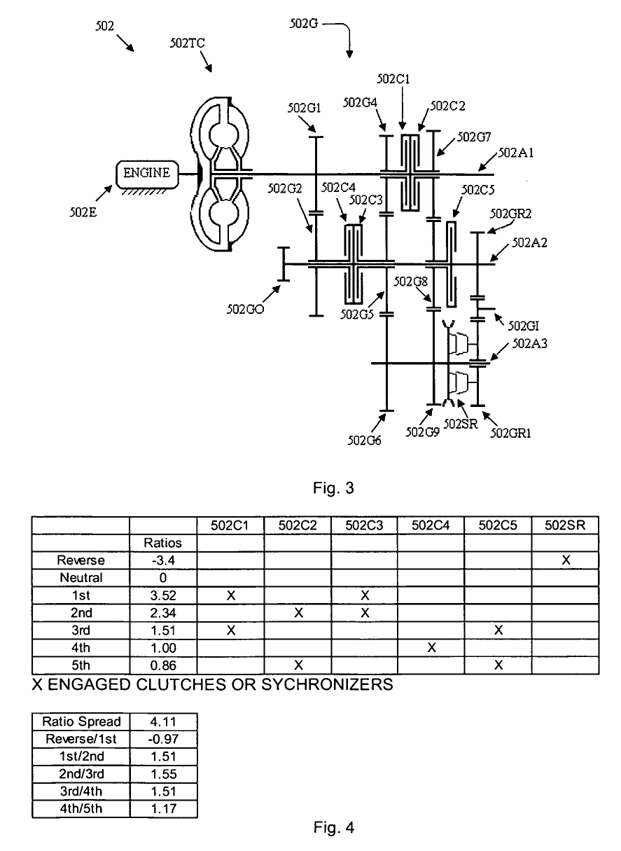

A powertrain system 502, shown in FIG. 3, has a conventional engine 502E, torque converter 502TC and a five-speed transmission gearbox 502G.

The five-speed transmission gearbox 502G includes an input shaft 502A1, an output shaft 502A2 which has a fixed output gearwheel 502GO to transmit torque to a final drive(not shown) and an intermediate shaft 502A3. 502A1 is selectively interconnected with 502C0. 502G also includes a plurality of forward driving gearwheels 502G1, which is fixed on 502A1, 502G2, 502G4, 502G5, 502G6, 502G7, 502G8 and 502G9 which are free to rotate and selectively interconnected with input shaft 502A1, the output shaft 502A2 and the intermediate shaft 502A3 by clutches 502C1, 502C2, 502C3, 502C4 and 502C5, and a synchronizer 502S1, respectively. 502G6 and 502G9 are linked with each other and fixed on the intermediate shaft 502A3. 502G also has a reverse driving gearwheel 502GR1 which is free to rotate and selectively interconnected with the intermediate shaft 502A3, a reverse driven gearwheel 502GR2 which is fixed on output shaft 502A2 and 502GI which serves as an idler to change rotating direction. The clutches allow 502G4 and 502G7 to be selectively interconnected with the input shaft 502A1, and 502G2, 502G5 and 502G8 to be selectively interconnected with the output shaft 502A2, respectively. The engagement and disengagement of torque transmitting mechanisms are controlled by conventional electro-hydraulic mechanism, not shown, which includes a programmable digital computer. Such control mechanisms are well known to those skilled in the art.

A static truth table, shown in FIG. 4, gives shift sequence of transmission of FIG. 3 and ratio steps between adjacent drive ratios.

When a forward speed is accomplished, main clutch 502C0 is always engaged. In addition, the following clutch and synchronizer engagements are applied. The first forward speed ratio is established by engagement of clutches 502C1 and 502C3. This results in gearwheel 502G4 driving gearwheel 502G5 to provide first forward speed ratio. The second forward speed ratio is established by engagement of clutches 502C2 and 502C3. This results in 502G7 driving 502G9 through the idler 502G8. Since 502G6 and 502G9 are linked, 502G6 drives 502G5 through the clutch 502C2's engagement to give reduced speed at the output shaft 502A2. The third forward speed ratio is established by engagement of clutches 502C1 and 502C5. This results in 502G4 driving 502G6 through the idler 502G5. Since 502G6 and 502G9 is linked, 502G9 drives 502G8 through the 502C5's engagement to give third reduced speed at the output shaft 502A2. The fourth forward speed ratio is established by engagement of clutches 502C4 only. This results in 502G1 driving 502G2 through the 502C4's engagement to give fourth speed at the output shaft 502A2. The fifth forward speed ratio is established by engagement of clutches 502C2 and 502C5. This results in 502G7 driving 502G8 to give the fifth speed at the output shaft 502A2. The reverse speed ratio is established by the engagements of clutch 502C1 and synchronizer 502SR. This results in 502G4 driving 502G6 through the idler 502G5. Since 502G6 and 502GR1 are linked through engagement of synchronizer 502SR, 502GR1 drives 502GR2 through the idler 502GI to give a reverse speed in reverse direction at the output shaft 502A2.

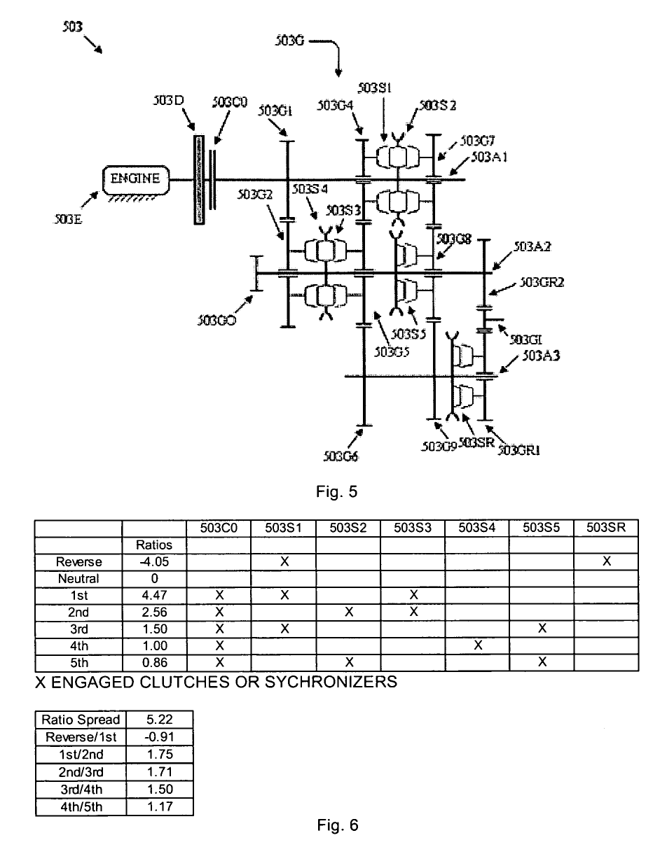

A powertrain system 503, shown in FIG. 5, has a conventional engine 503E and a five-speed transmission gearbox 503G.

The five-speed transmission gearbox 503G includes a mechanical damper 503D, which has connection between a main clutch 503C0 and an input shaft 503A1, an output shaft 503A2 which has a fixed output gearwheel 503GO to transmit torque to a final drive(not shown) and an intermediate shaft 503A3. 503A1 is selectively interconnected with 503C0. 503G also includes a plurality of forward driving gearwheels 503G1, which is fixed on 503A1, 503G2, 503G4, 503G5, 503G6, 503G7, 503G8 and 503G9 which are free to rotate and selectively interconnected with input shaft 503A1, the output shaft 503A2 and the intermediate shaft 503A3 by synchronizers 503S1, 503S2, 503S3, 503S4 and 503S5, respectively. 503G6 and 503G9 are linked with each other and fixed on the intermediate shaft 503A3. 503G also has a reverse driving gearwheel 503GR1 which is free to rotate and selectively interconnected with the intermediate shaft 503A3, a reverse driven gearwheel 503GR2 which is fixed on output shaft 503A2 and 503GI which serves as an idler to change rotating direction. The synchronizers allow 503G4 and 503G7 to be selectively interconnected with the input shaft 503A1, and 503G2, 503G5 and 503G8 to be selectively interconnected with the output shaft 503A2, respectively. The engagement and disengagement of torque transmitting mechanisms are controlled by conventional electro-hydraulic mechanism, not shown, which includes a programmable digital computer. Such control mechanisms are well known to those skilled in the art.

A static truth table, shown in FIG. 6, gives shift sequence of transmission of FIG. 5 and ratio steps between adjacent drive ratios.

When a forward speed is accomplished, main clutch 503C0 is always engaged. In addition, the following synchronizer engagements are applied. The first forward speed ratio is established by engagement of synchronizers 503S1 and 503S3. This results in gearwheel 503G4 driving gearwheel 503G5 to provide first forward speed ratio. The second forward speed ratio is established by engagement of synchronizers 503S2 and 503S3. This results in 503G7 driving 503G9 through the idler 503G8. Since 503G6 and 503G9 are linked, 503G6 drives 503G5 through the synchronizer 503S2's engagement to give reduced speed at the output shaft 503A2. The third forward speed ratio is established by engagement of synchronizers 503S1 and 503S5. This results in 503G4 driving 503G6 through the idler 503G5. Since 503G6 and 503G9 is linked, 503G9 drives 503G8 through the 503S5's engagement to give third reduced speed at the output shaft 503A2. The fourth forward speed ratio is established by engagement of synchronizers 503S4 only. This results in 503G1 driving 503G2 through the 503S4's engagement to give fourth speed at the output shaft 503A2. The fifth forward speed ratio is established by engagement of synchronizers 503S2 and 503S5. This results in 503G7 driving 503G8 to give the fifth speed at the output shaft 503A2. The reverse speed ratio is established by the engagements of synchronizer 503S1 and synchronizer 503SR. This results in 503G4 driving 503G6 through the idler 503G5. Since 503G6 and 503GR1 are linked through engagement of synchronizer 503SR, 503GR1 drives 503GR2 through the idler 503GI to give a reverse speed in reverse direction at the output shaft 503A2.

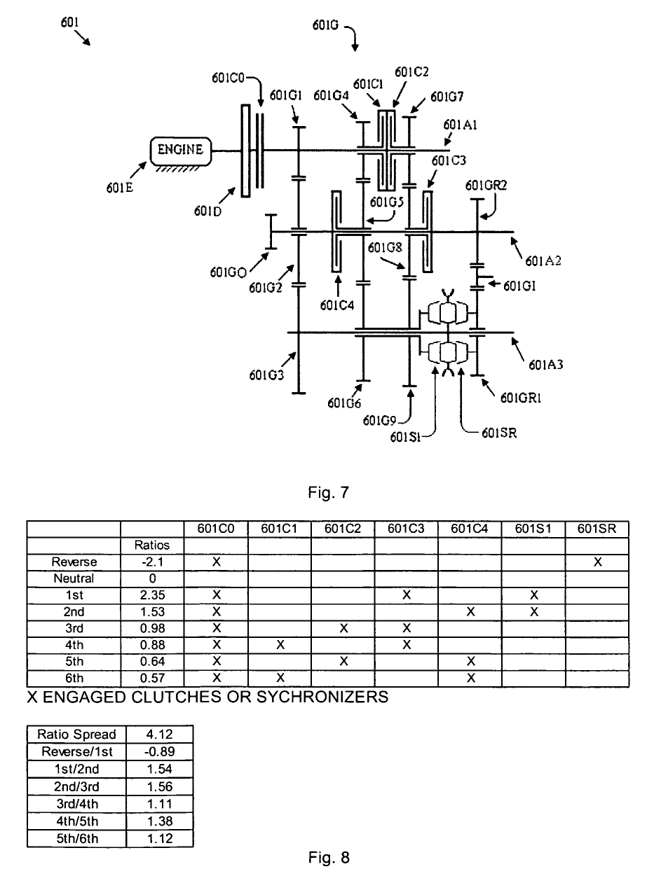

A powertrain system 601, shown in FIG. 7, has a conventional engine 601E and a six-speed transmission gearbox 601G using nine forward driving gearwheels.

The six-speed transmission gearbox 601G includes a mechanical damper 601D, which has connection between a main clutch 601C0 and an input shaft 601A1. 601G also includes forward driving gearwheels 601G1 and 601G3, which are fixed on the input shaft 601A1 and the intermediate shaft 601A3, respectively. A forward driving gearwheel 601G2 is free to rotate on the output shaft 601A2 to serve as an idler. The forward driving gearwheels 601G4, 601G5, 601G6, 601G7, 601G8 and 601G9 are free to rotate on input shaft 601A1, the output shaft 601A2 which has a fixed output gearwheel 601GO to transmit torque to a final drive(not shown) and an intermediate shaft 601A3, respectively. They are also selectively interconnected with input shaft 601A1, output shaft 601A2 and intermediate shaft 601A3 by clutches 601C1, 601C2, 601C3, 601C4, 601C5 and synchronizer 604S1, respectively. The selective interconnection of 601G6 and 601G9 to the intermediate shaft 601A3 gives two different connections, i.e. 601G3 with 601G6 and 601G9, and 601G6 with 601G9. The synchronizer 601S1 is fixed on the intermediate shaft 601A3 and selectively interconnected with the linked 601G6 and 601G9. The clutches 601C1 and 601C2 allow 601G4 and 601G7 to be selectively interconnected on the input shaft 601A1 and the clutches 601C3 and 601C4 also allow 601G5 and 601G8 to be selectively interconnected on the output shaft 601A2, respectively. 601G also has reverse gearwheel 601GR1 which is free to rotate on the intermediate shaft 601A3 and selectively interconnected with the intermediate shaft 601A3 through synchronizer 601SR, gearwheel 601GR2 which is fixed on output shaft 601A2 and 601GI which serves as an idler to enable 601A2 in the same rotating direction of 601A1. The engagement and disengagement of the clutches are controlled by conventional electro-hydraulic mechanism, not shown, which includes a programmable digital computer. Such control mechanisms are well known to those skilled in the art.

A static truth table, shown in FIG. 8, gives shift sequence of transmission of FIG. 7 and ratio steps between adjacent drive ratios.

When a forward speed is accomplished, main clutch 601C0 is always engaged. In addition, the following clutch and synchronizer engagements are applied. The first forward speed ratio is established by engagement of clutches 601C3 and 601S1. This results in gearwheel 601G1 driving gearwheel 601G3 through the idler 601G2. Since 601G3 is linked to 601G9 by the synchronizer 601S1, 601G8 is driven by 601G9 to provide the first forward speed at the output shaft 601A2. The second forward speed ratio is established by engagement of the synchronizer 601S1 and the clutch 601C4. This results in gearwheel 601G1 driving gearwheel 601G3 through the idler 601G2. Since 601G3 is linked to 601G6 by the synchronizer 601S1, 601G5 is driven by 601G6 to provide the second forward speed at the output shaft 601A2. The third forward speed ratio is established by engagement of clutches 601C2 and 601C3. This results in 601G7 driving 601G8 to give third reduced speed at the output shaft 601A2. The fourth forward speed ratio is established by engagement of clutches 601C1 and 601C3. This results in 601G4 driving 601G6 through the idler 601G5. Since 601G6 and 601G9 are linked, 601G8 is driven by 601G9 to give fourth speed at the output shaft 601A2. The fifth forward speed ratio is established by engagement of clutches 601C2 and 601C4. This results in 601G7 driving 601G9 through the idler 601G8. Since 601G6 and 601G9 are linked, 601G5 is driven by 601G6 to give fifth speed at the output shaft 601A2. The sixth forward speed ratio is established by engagement of clutches 601C1 and 601C4. This results in 601G4 driving 601G5 to give the sixth speed at the output shaft 601A2. The reverse speed ratio is established by engagement of synchronizer 601SR. This results in 601G1 driving 601G3 through the idler 601G2. Since 601G3 and 601GR1 are linked through the engaged synchronizer 601SR, 601GR1 drives 601GR2 through idler 601GI to give a reverse speed at the output shaft 601A2.

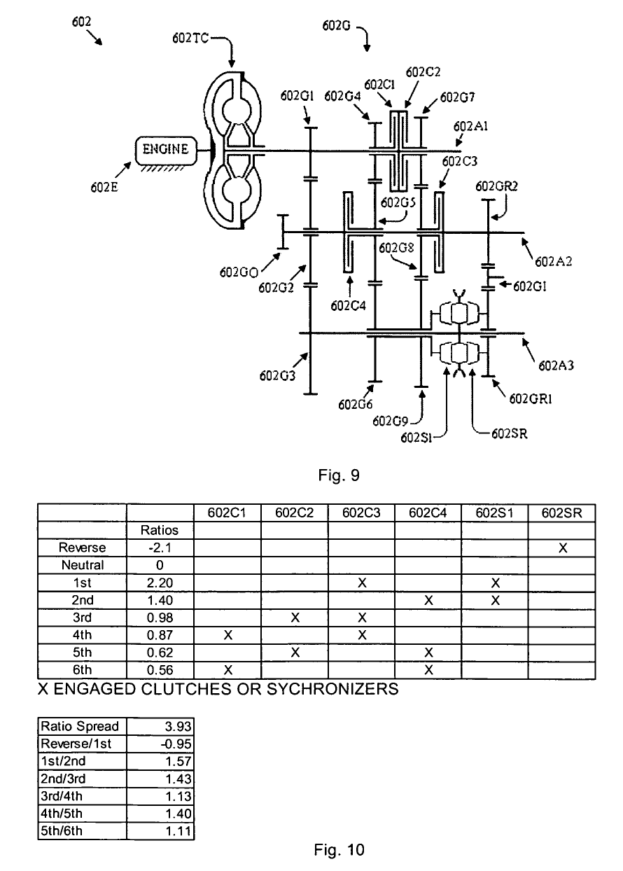

A powertrain system 602, shown in FIG. 9, has a conventional engine 602E and a six-speed transmission gearbox 602G using nine forward driving gearwheels.

The six-speed transmission gearbox 602G includes a torque converter 602TC to be connected to an input shaft 602A1. 602G also includes forward driving gearwheels 602G1 and 602G3, which are fixed on the input shaft 602A1 and the intermediate shaft 602A3, respectively. A forward driving gearwheel 602G2 is free to rotate on the output shaft 602A2 to serve as an idler. The forward driving gearwheels 602G4, 602G5, 602G6, 602G7, 602G8 and 602G9 are free to rotate on input shaft 602A1, the output shaft 602A2 which has a fixed output gearwheel 602GO to transmit torque to a final drive(not shown) and an intermediate shaft 602A3, respectively. They are also selectively interconnected with input shaft 602A1, output shaft 602A2 and intermediate shaft 602A3 by clutches 602C1, 602C2, 602C3, 602C4, 602C5 and synchronizer 604S1, respectively. The selective interconnection of 602G6 and 602G9 to the intermediate shaft 602A3 gives two different connections, i.e. 602G3 with 602G6 and 602G9, and 602G6 with 602G9. The synchronizer 602S1 is fixed on the intermediate shaft 602A3 and selectively interconnected with the linked 602G6 and 602G9. The clutches 602C1 and 602C2 allow 602G4 and 602G7 to be selectively interconnected on the input shaft 602A1 and the clutches 602C3 and 602C4 also allow 602G5 and 602G8 to be selectively interconnected on the output shaft 602A2, respectively. 602G also has reverse gearwheel 602GR1 which is free to rotate on the intermediate shaft 602A3 and selectively interconnected with the intermediate shaft 602A3 through synchronizer 602SR, gearwheel 602GR2 which is fixed on output shaft 602A2 and 602GI which serves as an idler to enable 602A2 in the same rotating direction of 602A1. The engagement and disengagement of the clutches are controlled by conventional electro-hydraulic mechanism, not shown, which includes a programmable digital computer. Such control mechanisms are well known to those skilled in the art.

A static truth table, shown in FIG. 10, gives shift sequence of transmission of FIG. 9 and ratio steps between adjacent drive ratios.

When a forward speed is accomplished, main clutch 602C0 is always engaged. In addition, the following clutch and synchronizer engagements are applied. The first forward speed ratio is established by engagement of clutches 602C3 and 602S1. This results in gearwheel 602G1 driving gearwheel 602G3 through the idler 602G2. Since 602G3 is linked to 602G9 by the synchronizer 602S1, 602G8 is driven by 602G9 to provide the first forward speed at the output shaft 602A2. The second forward speed ratio is established by engagement of the synchronizer 602S1 and the clutch 602C4. This results in gearwheel 602G1 driving gearwheel 602G3 through the idler 602G2. Since 602G3 is linked to 602G6 by the synchronizer 602S1, 602G5 is driven by 602G6 to provide the second forward speed at the output shaft 602A2. The third forward speed ratio is established by engagement of clutches 602C2 and 602C3. This results in 602G7 driving 602G8 to give third reduced speed at the output shaft 602A2. The fourth forward speed ratio is established by engagement of clutches 602C1 and 602C3. This results in 602G4 driving 602G6 through the idler 602G5. Since 602G6 and 602G9 are linked, 602G8 is driven by 602G9 to give fourth speed at the output shaft 602A2. The fifth forward speed ratio is established by engagement of clutches 602C2 and 602C4. This results in 602G7 driving 602G9 through the idler 602G8. Since 602G6 and 602G9 are linked, 602G5 is driven by 602G6 to give fifth speed at the output shaft 602A2. The sixth forward speed ratio is established by engagement of clutches 602C1 and 602C4. This results in 602G4 driving 602G5 to give the sixth speed at the output shaft 602A2. The reverse speed ratio is established by engagement of synchronizer 602SR. This results in 602G1 driving 602G3 through the idler 602G2. Since 602G3 and 602GR1 are linked through the engaged synchronizer 602SR, 602GR1 drives 602GR2 through idler 602GI to give a reverse speed at the output shaft 602A2.

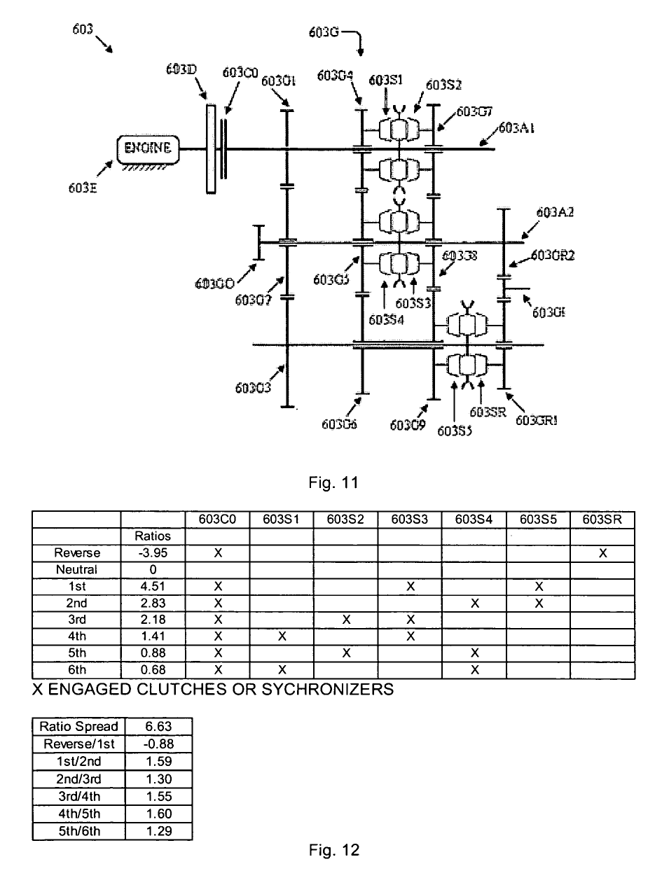

A powertrain system 603, shown in FIG. 11, has a conventional engine 603E and a six-speed transmission gearbox 603G using nine forward driving gearwheels.

The six-speed transmission gearbox 603G includes a mechanical damper 603D, which has connection between a main clutch 603C0 and an input shaft 603A1. 603G also includes forward driving gearwheels 603G1 and 603G3, which are fixed on the input shaft 603A1 and the intermediate shaft 603A3, respectively. A forward driving gearwheel 603G2 is free to rotate on the output shaft 603A2 to serve as an idler. The forward driving gearwheels 603G4, 603G5, 603G6, 603G7, 603G8 and 603G9 are free to rotate on input shaft 603A1, the output shaft 603A2 which has a fixed output gearwheel 603GO to transmit torque to a final drive(not shown) and an intermediate shaft 603A3, respectively. They are also selectively interconnected with input shaft 603A1, output shaft 603A2 and intermediate shaft 603A3 by synchronizers 603S1, 603S2, 603S3, 603S4 and 603S5, respectively. The selective interconnection of 603G6 and 603G9 to the intermediate shaft 603A3 gives two different connections, i.e. 603G3 with 603G6 and 603G9, and 603G6 with 603G9. The synchronizer 603S5 is fixed on the intermediate shaft 603A3 and selectively interconnected with the linked 603G6 and 603G9. The synchronizers 603S1 and 603S2 allow 603G4 and 603G7 to be selectively interconnected on the input shaft 603A1 and the synchronizers 603S3 and 603S4 also allow 603G5 and 603G8 to be selectively interconnected on the output shaft 603A2, respectively. 603G also has reverse gearwheel 603GR1 which is free to rotate on the intermediate shaft 603A3 and selectively interconnected with the intermediate shaft 603A3 through synchronizer 603SR, gearwheel 603GR2 which is fixed on output shaft 603A2 and 603GI which serves as an idler to enable 603A2 in the same rotating direction of 603A1. The engagement and disengagement of the synchronizers are controlled by conventional electro-hydraulic mechanism, not shown, which includes a programmable digital computer. Such control mechanisms are well known to those skilled in the art.

A static truth table, shown in FIG. 12, gives shift sequence of transmission of FIG. 11 and ratio steps between adjacent drive ratios.

When a forward speed is accomplished, main synchronizer 603C0 is always engaged. In addition, the following synchronizer and synchronizer engagements are applied. The first forward speed ratio is established by engagement of synchronizers 603S3 and 603S5. This results in gearwheel 603G1 driving gearwheel 603G3 through the idler 603G2. Since 603G3 is linked to 603G9 by the synchronizer 603S5, 603G8 is driven by 603G9 to provide the first forward speed at the output shaft 603A2. The second forward speed ratio is established by engagement of the synchronizer 603S4 and the synchronizer 603S5. This results in gearwheel 603G1 driving gearwheel 603G3 through the idler 603G2. Since 603G3 is linked to 603G6 by the synchronizer 603S5, 603G5 is driven by 603G6 to provide the second forward speed at the output shaft 603A2. The third forward speed ratio is established by engagement of synchronizers 603S2 and 603S3. This results in 603G7 driving 603G8 to give third reduced speed at the output shaft 603A2. The fourth forward speed ratio is established by engagement of synchronizers 603S1 and 603S3. This results in 603G4 driving 603G6 through the idler 603G5. Since 603G6 and 603G9 are linked, 603G8 is driven by 603G9 to give fourth speed at the output shaft 603A2. The fifth forward speed ratio is established by engagement of synchronizers 603S2 and 603S4. This results in 603G7 driving 603G9 through the idler 603G8. Since 603G6 and 603G9 are linked, 603G5 is driven by 603G6 to give fifth speed at the output shaft 603A2. The sixth forward speed ratio is established by engagement of synchronizers 603S1 and 603S4. This results in 603G4 driving 603G5 to give the sixth speed at the output shaft 603A2. The reverse speed ratio is established by engagement of synchronizer 603SR. This results in 603G1 driving 603G3 through the idler 603G2. Since 603G3 and 603GR1 are linked through the engaged synchronizer 603SR, 603GR1 drives 603GR2 through idler 603GI to give a reverse speed at the output shaft 603A2.

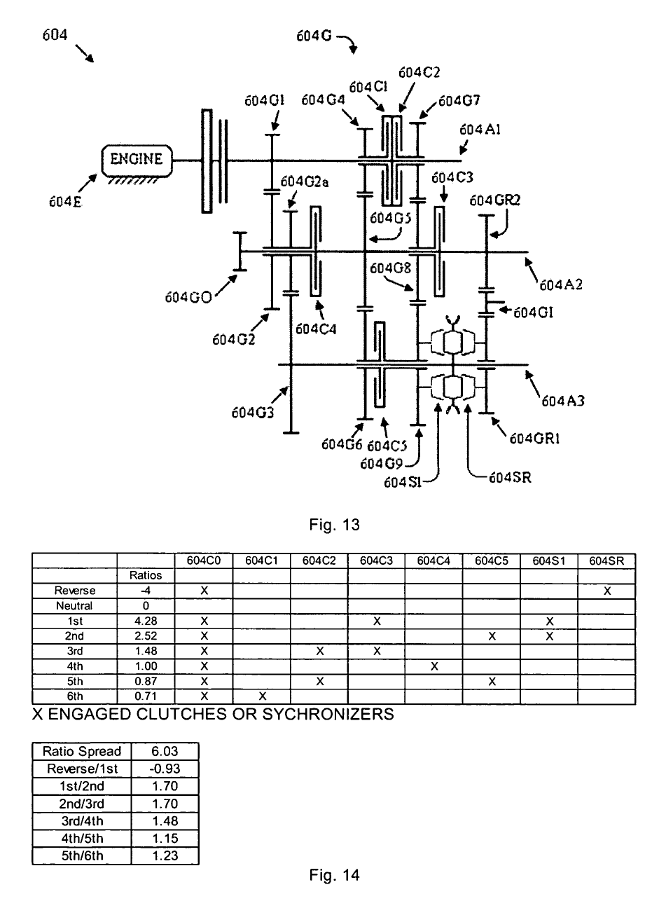

A powertrain system 604, shown in FIG. 13, has a conventional engine 604E and a six-speed transmission gearbox 604G using ten forward driving gearwheels.

The six-speed transmission gearbox 604G includes a mechanical damper 604D, which has connection between a main clutch 604C0 and an input shaft 604A1. 604G also includes forward driving gearwheels 604G1 and 604G3, which are fixed on the input shaft 604A1 and the intermediate shaft 604A3, respectively. Two linked forward driving gearwheels 604G2 and 604G2a are free to rotate on the output shaft 604A2 and they are selectively interconnected with the output shaft 604A2 by clutch 604C4. The forward driving gearwheels 604G4, 604G6, 604G7, 604G8 and 604G9 are free to rotate and selectively interconnected with input shaft 604A1, output shaft 604A2 which has a fixed output gearwheel 604GO to transmit torque to a final drive(not shown) and intermediate shaft 604A3 by clutches 604C1, 604C2, 604C3, 604C5 and synchronizer 604S1, respectively. 604G3, 604G6 and 604G9 are selectively interconnected to generate three different connections, i.e. 604G3 with 604G9, 604G3 with 604G6 and 604G9, and 604G6 with 604G9. The synchronizer 604S1 is fixed on the intermediate shaft 604A3 and selectively interconnected with 604G9. The clutches 604C1 and 604C2 allow 604G4 and 604G7 to be selectively interconnected on the input shaft 604A1 and the clutches 604C3 and 604C4 also allow 604G8 and the linked 604G2 and 604G2a to be selectively interconnected on the output shaft 604A2, respectively. 604G also has a reverse gearwheel 604GR1 which is free to rotate and selectively interconnected with the intermediate shaft 604A3 through synchronizer 604SR, gearwheel 604GR2 which is fixed on output shaft 604A2 and 604GI which serves as an idler to provide the same rotating direction of 604A1. The engagement and disengagement of the clutches are controlled by conventional electro-hydraulic mechanism, not shown, which includes a programmable digital computer. Such control mechanisms are well known to those skilled in the art.

A static truth table, shown in FIG. 14, gives shift sequence of transmission of FIG. 13 and ratio steps between adjacent drive ratios.

When a forward speed is accomplished, main clutch 604C0 is always engaged. In addition, the following clutch and synchronizer engagements are applied. The first forward speed ratio is established by engagement of clutches 604C3 and 604S1. This results in gearwheel 604G1 driving the linked gearwheels 604G2 and 604G2a. Since 604G2a drives 604G3 and 604G3 is interconnected with 604G9 through the engagement of synchronizer 604S1, 604G8 is driven by 604G9 to provide first forward speed at the output shaft 604A2. The second forward speed ratio is established by engagement of synchronizer 604S1 and 604C5. This also results in gearwheel 604G1 driving linked gearwheels 604G2 and 604G2a. Since 604G2a drives 604G3 and 604G3 is connected with 604G6 through the engagements of clutch 604C5 and synchronizer 604S1, 604G5 is driven by 604G6 to provide the second forward speed at the output shaft 604A2. When shifting from the first gear to the second gear, the relative slippery speed between the driving and driven clutch pads on 604C5 is reduced. The reason is that the driving clutch pad speed on intermediate shaft is reduced by the higher gear ratio of 604G1, 604G2, 604G2a and 604G3 while the driven clutch pad speed is reduced by lower gear ratio of 604G5 and 604G6. This gives the lower relative speed of driving and driven clutch pads before the engagement of 604C5. The third forward speed ratio is established by engagement of clutches 604C2 and 604C3. This results in 604G7 driving 604G8 to give third reduced speed at the output shaft 604A2. The fourth forward speed ratio is established by engagement of clutch 604C4 only. This results in 604G1 driving 604G2 to give fourth speed at the output shaft 604A2. The fifth forward speed ratio is established by engagement of clutch 604C2 and 604C5. This results in 604G7 driving 604G9 through the idler 604G8. Since 604G9 is interconnected with 604G6 through the engagement of clutch 604C5, 604G5 is driven by 604G6 to give fifth speed at the output shaft 604A2. The sixth forward speed ratio is established by engagement of clutches 604C1 only. This results in 604G4 driving 604G5 to give the sixth speed at the output shaft 604A2. The reverse speed ratio is established by engagement of synchronizer 604SR. This results in 604G1 driving 604G2 and 604G2a driving 604G3. Since 604G3 and 604GR1 are interconnected through the engaged synchronizer 604SR, 604GR1 drives 604GR2 through idler 604GI to give a reverse speed at the output shaft 604A2.

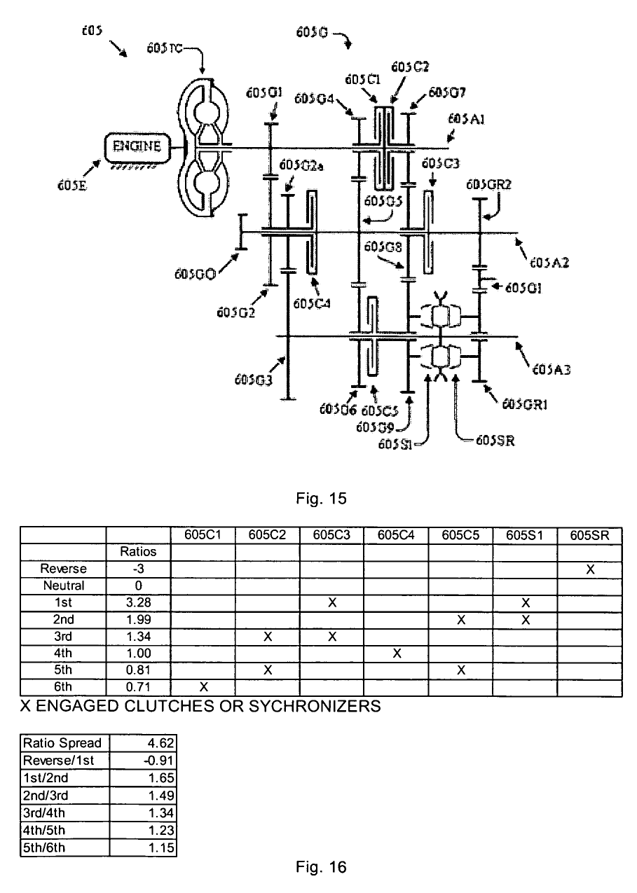

A powertrain system 605, shown in FIG. 15, has a conventional engine 605E and a six-speed transmission gearbox 605G using ten forward driving gearwheels.

The six-speed transmission gearbox 605G includes a torque converter 605TC to be connected to an input shaft 605A1. 605G also includes forward driving gearwheels 605G1 and 605G3, which are fixed on the input shaft 605A1 and the intermediate shaft 605A3, respectively. Two linked forward driving gearwheels 605G2 and 605G2a are free to rotate on the output shaft 605A2 and they are selectively interconnected with the output shaft 605A2 by clutch 605C4. The forward driving gearwheels 605G4, 605G6, 605G7, 605G8 and 605G9 are free to rotate and selectively interconnected with input shaft 605A1, output shaft 605A2 which has a fixed output gearwheel 605GO to transmit torque to a final drive(not shown) and intermediate shaft 605A3 by clutches 605C1, 605C2, 605C3, 605C5 and synchronizer 605S1, respectively. 605G3, 605G6 and 605G9 are selectively interconnected to generate three different connections, i.e. 605G3 with 605G9, 605G3 with 605G6 and 605G9, and 605G6 with 605G9. The synchronizer 605S1 is fixed on the intermediate shaft 605A3 and selectively interconnected with 605G9. The clutches 605C1 and 605C2 allow 605G4 and 605G7 to be selectively interconnected on the input shaft 605A1 and the clutches 605C3 and 605C4 also allow 605G8 and the linked 605G2 and 605G2a to be selectively interconnected on the output shaft 605A2, respectively. 605G also has a reverse gearwheel 605GR1 which is free to rotate and selectively interconnected with the intermediate shaft 605A3 through synchronizer 605SR, gearwheel 605GR2 which is fixed on output shaft 605A2 and 605GI which serves as an idler to provide the same rotating direction of 605A1. The engagement and disengagement of the clutches are controlled by conventional electro-hydraulic mechanism, not shown, which includes a programmable digital computer. Such control mechanisms are well known to those skilled in the art.

A static truth table, shown in FIG. 16, gives shift sequence of transmission of FIG. 15 and ratio steps between adjacent drive ratios.

When a forward speed is accomplished, main clutch 605C0 is always engaged. In addition, the following clutch and synchronizer engagements are applied. The first forward speed ratio is established by engagement of clutches 605C3 and 605S1. This results in gearwheel 605G1 driving the linked gearwheels 605G2 and 605G2a. Since 605G2a drives 605G3 and 605G3 is interconnected with 605G9 through the engagement of synchronizer 605S1, 605G8 is driven by 605G9 to provide first forward speed at the output shaft 605A2. The second forward speed ratio is established by engagement of synchronizer 605S1 and 605C5. This also results in gearwheel 605G1 driving linked gearwheels 605G2 and 605G2a. Since 605G2a drives 605G3 and 605G3 is connected with 605G6 through the engagements of clutch 605C5 and synchronizer 605S1, 605G5 is driven by 605G6 to provide the second forward speed at the output shaft 605A2. When shifting from the first gear to the second gear, the relative slippery speed between the driving and driven clutch pads on 605C5 is reduced. The reason is that the driving clutch pad speed on intermediate shaft is reduced by the higher gear ratio of 605G1, 605G2, 605G2a and 605G3 while the driven clutch pad speed is reduced by lower gear ratio of 605G5 and 605G6. This gives the lower relative speed of driving and driven clutch pads before the engagement of 605C5. The third forward speed ratio is established by engagement of clutches 605C2 and 605C3. This results in 605G7 driving 605G8 to give third reduced speed at the output shaft 605A2. The fourth forward speed ratio is established by engagement of clutch 605C4 only. This results in 605G1 driving 605G2 to give fourth speed at the output shaft 605A2. The fifth forward speed ratio is established by engagement of clutch 605C2 and 605C5. This results in 605G7 driving 605G9 through the idler 605G8. Since 605G9 is interconnected with 604G6 through the engagement of clutch 605C5, 605G5 is driven by 605G6 to give fifth speed at the output shaft 605A2. The sixth forward speed ratio is established by engagement of clutches 605C1 only. This results in 605G4 driving 605G5 to give the sixth speed at the output shaft 605A2. The reverse speed ratio is established by engagement of synchronizer 605SR. This results in 605G1 driving 605G2 and 605G2a driving 605G3. Since 605G3 and 605GR1 are interconnected through the engaged synchronizer 605SR, 605GR1 drives 605GR2 through idler 605GI to give a reverse speed at the output shaft 605A2.

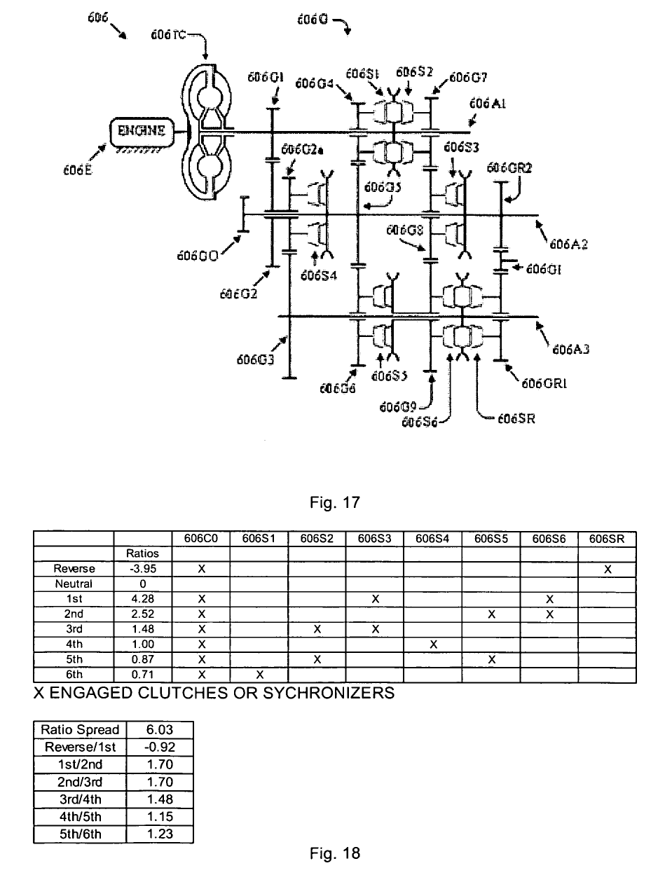

A powertrain system 606, shown in FIG. 17, has a conventional engine 606E and a six-speed transmission gearbox 606G using ten forward driving gearwheels.

The six-speed transmission gearbox 606G includes a mechanical damper 606D, which has connection between a main clutch 606C0 and an input shaft 606A1. 606G also includes forward driving gearwheels 606G1, 606G3 and 601G8, which are fixed on the input shaft 606A1, the intermediate shaft 606A3 and output shaft 606A2, respectively. Two linked forward driving gearwheels 606G2 and 606G2a are free to rotate on the output shaft 606A2 and they are selectively interconnected with the output shaft 606A2 by synchronizer 606S4. The forward driving gearwheels 606G4, 606G5, 606G6, 606G7 and 606G9 are free to rotate and selectively interconnected with input shaft 606A1, output shaft 606A2 and intermediate shaft 606A3 by synchronizers 606S1, 606S2, 606S3, 606S5 and 606S6, respectively. 606G3, 606G6 and 606G9 are selectively interconnected by 606S5 and 606S6 to generate three different connections, i.e. 606G3 with 606G9, 606G3 with 606G6 and 606G9, and 606G6 with 606G9. The synchronizer 606S6 is fixed on the intermediate shaft 606A3 and selectively interconnected with 606G9. The synchronizers 606S1 and 606S2 allow 606G4 and 606G7 to be selectively interconnected on the input shaft 606A1 and the synchronizers 606S3 and 606S4 also allow 606G5 and the linked 606G2 and 606G2a to be selectively interconnected on the output shaft 606A2, respectively. 606G also has reverse gearwheel 606GR1 which is free to rotate and selectively interconnected with the intermediate shaft 606A3 through synchronizer 606SR, gearwheel 606GR2 which is fixed on output shaft 606A2 and 606GI which serves as an idler provides the same rotating direction of 606A1. The engagement and disengagement of the synchronizers are controlled by conventional electro-hydraulic mechanism, not shown, which includes a programmable digital computer. Such control mechanisms are well known to those skilled in the art.

A static truth table, shown in FIG. 18, gives shift sequence of transmission of FIG. 17 and ratio steps between adjacent drive ratios.

When a forward speed is accomplished, main synchronizer 606C0 is always engaged. In addition, the following synchronizer engagements are applied. The first forward speed ratio is established by engagement of synchronizers 606S3 and 606S6. This results in gearwheel 606G1 driving linked gearwheels 606G2 and 606G2a. Since 606G2a drives 606G3 and 606G3 is interconnected with 606G6 through synchronizer 606S6, 606G5 is driven by 606G6 to provide first forward speed at the output shaft 606A2. The second forward speed ratio is established by engagement of synchronizer 606S5 and 606S6. This also results in gearwheel 606G1 driving linked gearwheels 606G2 and 606G2a. Since 606G2a drives 606G3 and 606G3 is interconnected with 606G9 through the engaged synchronizer 606S5, 606G8 is driven by 606G9 to provide the second forward speed at the output shaft 606A2. The third forward speed ratio is established by engagement of synchronizers 606S2 and 606S3. This results in 606G4 driving 606G5 to give third reduced speed at the output shaft 606A2. The fourth forward speed ratio is established by engagement of synchronizer 606S4 only. This results in 606G1 driving 606G2 to give fourth speed at the output shaft 606A2. The fifth forward speed ratio is established by engagement of synchronizer 606S2 and 606S5. This results in 606G7 driving 606G9 through the idler 606G8. Since 606G9 is interconnected with 606G6 through the engaged synchronizer 606S6, 606G5 is driven by 606G6 to give fifth speed at the output shaft 606A2. The sixth forward speed ratio is established by engagement of synchronizers 606S1 only. This results in 606G7 driving 606G8 to give the sixth speed at the output shaft 606A2. The reverse speed ratio is established by engagement of synchronizer 606SR. This results in 606G1 driving 606G2 and 606G2a driving 606G3. Since 606G3 and 606GR1 are interconnected through the engaged synchronizer 606SR, 606GR1 drives 606GR2 through idler 606GI to give a reverse speed at the output shaft 606A2.

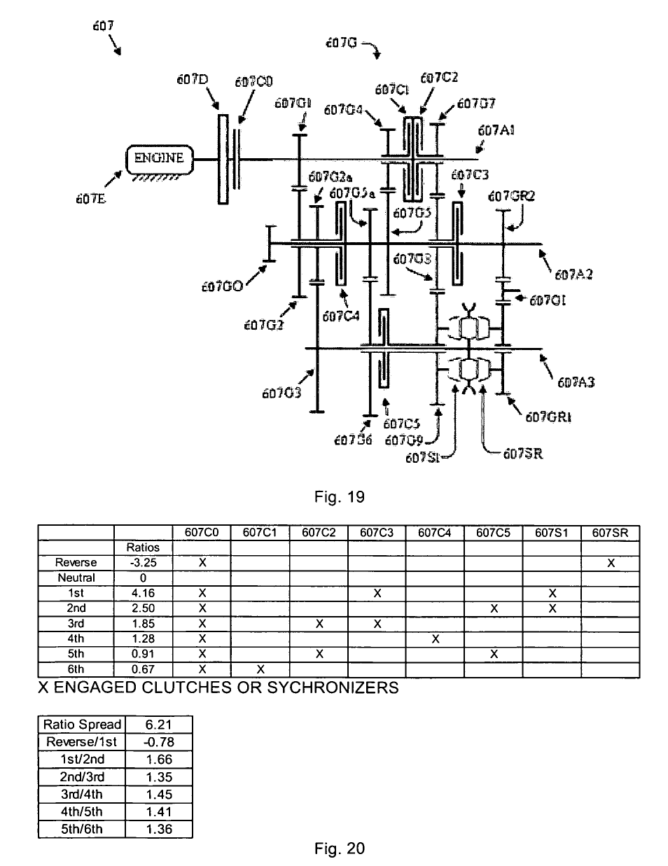

A powertrain system 607, shown in FIG. 19, has a conventional engine 607E and a six-speed transmission gearbox 607G using eleven forward driving gearwheels.

The six-speed transmission gearbox 607G includes a mechanical damper 607D, which has connection between a main clutch 607C0 and an input shaft 607A1, a torque converter 607TC to be connected to an input shaft 607A1. 607G also includes forward driving gearwheels 607G1 and 607G3, which are fixed on the input shaft 607A1 and the intermediate shaft 607A3, respectively. Two linked forward driving gearwheels 607G2 and 607G2a are free to rotate on the output shaft 607A2 to serve as an idler. The forward driving gearwheels 607G4, 607G5, 607G5a, 607G6, 607G7, 607G8 and 607G9 are free to rotate on input shaft 607A1, output shaft 607A2 which has a fixed output gearwheel 607GO to transmit torque to a final drive(not shown) and intermediate shaft 607A3, respectively. They are also selectively interconnected with input shaft 607A1, output shaft 607A2 and intermediate shaft 607A3 by clutches 607C1, 607C2, 607C3, 607C4, 607C5 and synchronizer 607S1, respectively. 607G5 and 607G5a are linked gearwheels. The selective interconnection of 607G3, 607G6 and 607G9 to the intermediate shaft 607A3 gives three different connections, i.e. 607G3 with 607G9, 607G3 with 607G6 and 607G9, and 607G6 with 607G9. The synchronizer 607S1 is fixed on the intermediate shaft 607A3 and selectively interconnected with 607G6. The clutches 607C1 and 607C2 allow 607G4 and 607G7 to be selectively interconnected on the input shaft 607A1 and the clutches 607C3 and 607C4 also allow linked 607G5 and 607G5a and 607G8 to be selectively interconnected on the output shaft 607A2, respectively. 607G also has reverse gearwheel 607GR1 which is free to rotate on the intermediate shaft 607A3 and selectively interconnected with the intermediate shaft 607A3 through synchronizer 607SR, gearwheel 607GR2 which is fixed on output shaft 607A2 and 607GI which serves as an idler to enable 607A2 in the same rotating direction of 607A1. The engagement and disengagement of the clutches are controlled by conventional electro-hydraulic mechanism, not shown, which includes a programmable digital computer. Such control mechanisms are well known to those skilled in the art.

A static truth table, shown in FIG. 20, gives shift sequence of transmission of FIG. 19 and ratio steps between adjacent drive ratios.

When a forward speed is accomplished, main clutch 607C0 is always engaged. In addition, the following clutch and synchronizer engagements are applied. The first forward speed ratio is established by engagement of clutches 607C3 and synchronizer 607S1. This results in gearwheel 607G1 driving gearwheel 607G3 through the linked idlers 607G2 and 607G2a. Since 607G3 is linked to 607G9 through clutch 607C3 and synchronizer 607S1, 607G8 is driven by 607G9 to provide the first forward speed at the output shaft 607A2. The second forward speed ratio is established by engagement of synchronizer 607S1 and clutch 607C5. This results in gearwheel 607G1 driving gearwheel 607G3 through the linked idlers 607G2 and 607G2a. Since 607G3 is linked to 607G6 through synchronizer 607S1, 607G5a is driven by 607G6 to provide the second forward speed at the output shaft 607A2. When shifting from the first gear to the second gear, the relative slippery speed between the driving and driven clutch pads on 607C5 is reduced. The reason is that the driving clutch pad speed on intermediate shaft is reduced by the higher gear ratio of 607G1, 607G2, 607G2a and 607G3 while the driven clutch pad speed is reduced by lower gear ratio of 607G5 and 607G6. This gives the lower relative speed of driving and driven clutch pads before the engagement of 607C5. The third forward speed ratio is established by engagement of clutches 607C2 and 607C3. This results in 607G7 driving 607G8 to give third forward speed at the output shaft 607A2. The fourth forward speed ratio is established by engagement of clutch 607C4 only. This results in 607G1 driving 607G2 to give fourth speed at the output shaft 607A2. The fifth forward speed ratio is established by engagement of clutches 607C2 and 607C5. This results in 607G7 driving 607G9 through the idler 607G8. Since 607G9 is linked to 607G6 through clutch 607C5, 607G5a is driven by 607G6 to give fifth speed at the output shaft 607A2. The sixth forward speed ratio is established by engagement of clutches 607C1 only. This results in 607G4 driving 607G5 to give the sixth speed at the output shaft 607A2. The reverse speed ratio is established by engagement of synchronizer 607SR. This results in 607G1 driving 607G3 through the idler 607G2. Since 607G3 and 607GR1 are linked through the engaged synchronizer 607SR, 607GR1 drives 607GR2 through idler 607GI to give a reverse speed at the output shaft 607A2.

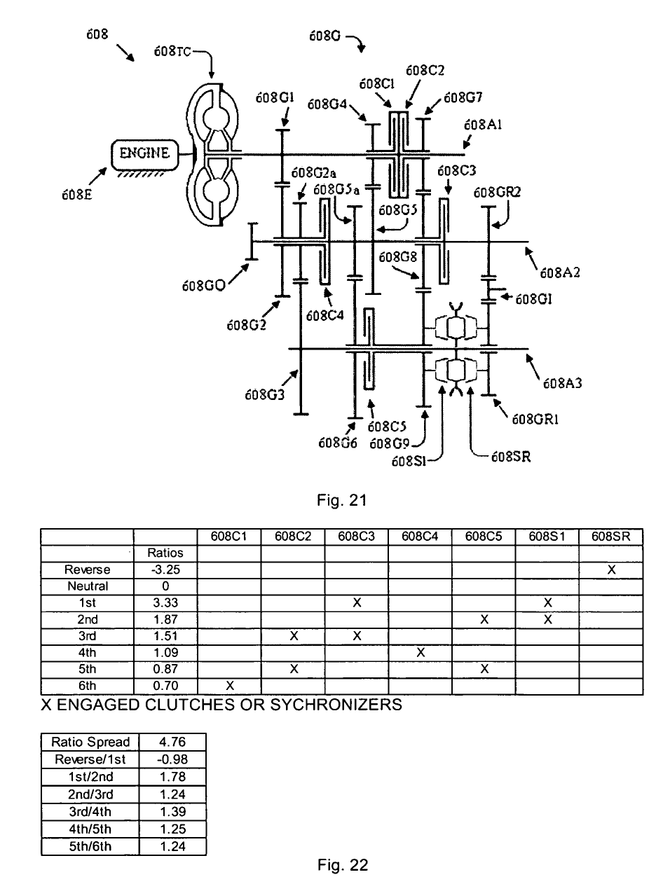

A powertrain system 608, shown in FIG. 21, has a conventional engine 608E and a six-speed transmission gearbox 608G using eleven forward driving gearwheels.

The six-speed transmission gearbox 608G includes a torque converter 608TC to be connected to an input shaft 608A1. 608G also includes forward driving gearwheels 608G1 and 608G3, which are fixed on the input shaft 608A1 and the intermediate shaft 608A3, respectively. Two linked forward driving gearwheels 608G2 and 608G2a are free to rotate on the output shaft 608A2 to serve as an idler. The forward driving gearwheels 608G4, 608G5, 608G5a, 608G6, 608G7, 608G8 and 608G9 are free to rotate on input shaft 608A1, output shaft 608A2 which has a fixed output gearwheel 608GO to transmit torque to a final drive(not shown) and intermediate shaft 608A3, respectively. They are also selectively interconnected with input shaft 608A1, output shaft 608A2 and intermediate shaft 608A3 by clutches 608C1, 608C2, 608C3, 608C4, 608C5 and synchronizer 608S1, respectively. 608G5 and 608G5a are linked gearwheels. The selective interconnection of 608G3, 608G6 and 608G9 to the intermediate shaft 608A3 gives three different connections, i.e. 608G3 with 608G9, 608G3 with 608G6 and 608G9, and 608G6 with 608G9. The synchronizer 608S1 is fixed on the intermediate shaft 608A3 and selectively interconnected with 608G6. The clutches 608C1 and 608C2 allow 608G4 and 608G7 to be selectively interconnected on the input shaft 608A1 and the clutches 608C3 and 608C4 also allow linked 608G5 and 608G5a and 608G8 to be selectively interconnected on the output shaft 608A2, respectively. 608G also has reverse gearwheel 608GR1 which is free to rotate on the intermediate shaft 608A3 and selectively interconnected with the intermediate shaft 608A3 through synchronizer 608SR, gearwheel 608GR2 which is fixed on output shaft 608A2 and 608GI which serves as an idler to enable 608A2 in the same rotating direction of 608A1. The engagement and disengagement of the clutches are controlled by conventional electro-hydraulic mechanism, not shown, which includes a programmable digital computer. Such control mechanisms are well known to those skilled in the art.

A static truth table, shown in FIG. 22, gives shift sequence of transmission of FIG. 21 and ratio steps between adjacent drive ratios.

When a forward speed is accomplished, main clutch 608C0 is always engaged. In addition, the following clutch and synchronizer engagements are applied. The first forward speed ratio is established by engagement of clutches 608C3 and 608S1. This results in gearwheel 608G1 driving gearwheel 608G3 through the linked idlers 608G2 and 608G2a. Since 608G3 is linked to 608G9 through clutch 608C3 and synchronizer 608S1, 608G8 is driven by 608G9 to provide the first forward speed at the output shaft 608A2. The second forward speed ratio is established by engagement of synchronizer 608S1 and 608C5. This results in gearwheel 608G1 driving gearwheel 608G3 through the linked idlers 608G2 and 608G2a. Since 608G3 is linked to 608G6 through synchronizer 608S1, 608G5a is driven by 608G6 to provide the second forward speed at the output shaft 608A2. When shifting from the first gear to the second gear, the relative slippery speed between the driving and driven clutch pads on 608C5 is reduced. The reason is that the driving clutch pad speed on intermediate shaft is reduced by the higher gear ratio of 608G1, 608G2, 608G2a and 608G3 while the driven clutch pad speed is reduced by lower gear ratio of 608G5a and 608G6. This gives the lower relative speed of driving and driven clutch pads before the engagement of 608C5. The third forward speed ratio is established by engagement of clutches 608C2 and 608C3. This results in 608G7 driving 608G8 to give third forward speed at the output shaft 608A2. The fourth forward speed ratio is established by engagement of clutch 608C4 only. This results in 608G1 driving 608G2 to give fourth speed at the output shaft 608A2. The fifth forward speed ratio is established by engagement of clutches 608C2 and 608C5. This results in 608G7 driving 608G9 through the idler 608G8. Since 608G9 is linked to 608G6 through clutch 608C5, 608G5a is driven by 608G6 to give fifth speed at the output shaft 608A2. The sixth forward speed ratio is established by engagement of clutches 608C1 only. This results in 608G4 driving 608G5 to give the sixth speed at the output shaft 608A2. The reverse speed ratio is established by engagement of synchronizer 608SR. This results in 608G1 driving 608G3 through the idler 608G2. Since 608G3 and 608GR1 are linked through the engaged synchronizer 608SR, 608GR1 drives 608GR2 through idler 608GI to give a reverse speed at the output shaft 608A2.

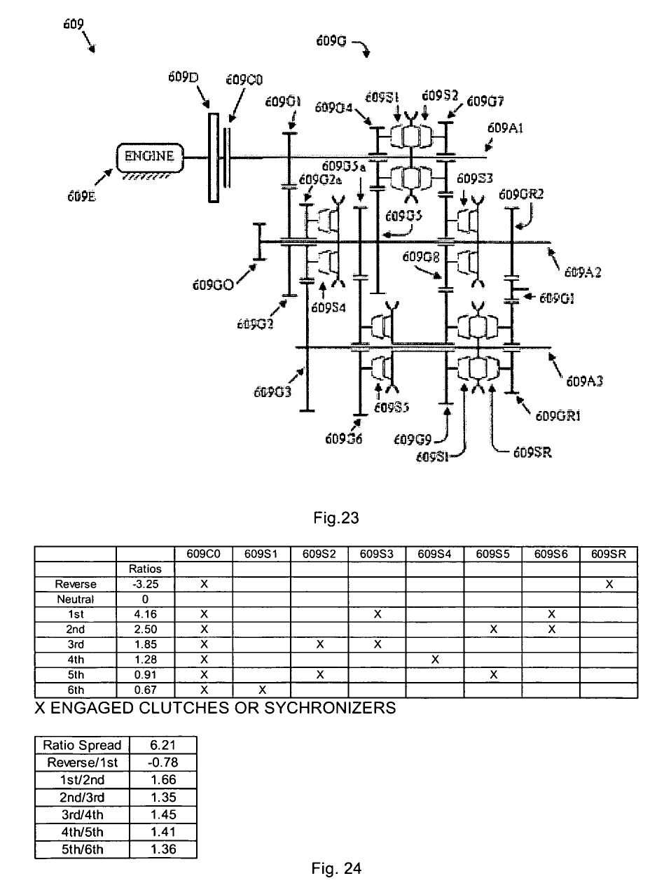

A powertrain system 609, shown in FIG. 23, has a conventional engine 609E and a six-speed transmission gearbox 609G using eleven forward driving gearwheels.

The six-speed transmission gearbox 609G includes a mechanical damper 609D, which has connection between a main clutch 609C0 and an input shaft 609A1. 609G also includes forward driving gearwheels 609G1, 609G3 and 601G8, which are fixed on the input shaft 609A1, the intermediate shaft 609A3 and output shaft 609A2, respectively. Two linked forward driving gearwheels 609G2 and 609G2a are free to rotate on the output shaft 609A2 and they are selectively interconnected with the output shaft 609A2 by synchronizer 609S4. The forward driving gearwheels 609G4, 609G5, 609G6, 609G7 and 609G9 are free to rotate and selectively interconnected with input shaft 609A1, output shaft 609A2 which has a fixed output gearwheel 609GO to transmit torque to a final drive(not shown) and intermediate shaft 609A3 by synchronizers 609S1, 609S2, 609S3, 609S5 and 609S6, respectively. 609G6 and 609G9 are selectively interconnected by 609S5 and 609S6 to generate three different connections, i.e. 609G3 with 609G9, 609G3 with 609G6 and 609G9, and 609G6 with 609G9. The synchronizer 609S6 is fixed on the intermediate shaft 609A3 and selectively interconnected with 609G9. The synchronizers 609S1 and 609S2 allow 609G4 and 609G7 to be selectively interconnected on the input shaft 609A1 and the synchronizers 609S3 and 609S4 also allow 609G5 and the linked 609G2 and 609G2a to be selectively interconnected on the output shaft 609A2, respectively. 609G also has reverse gearwheel 609GR1 which is free to rotate and selectively interconnected with the intermediate shaft 609A3 through synchronizer 609SR, gearwheel 609GR2 which is fixed on output shaft 609A2 and 609GI which serves as an idler provides the same rotating direction of 609A1. The engagement and disengagement of the synchronizers are controlled by conventional electro-hydraulic mechanism, not shown, which includes a programmable digital computer. Such control mechanisms are well known to those skilled in the art.

A static truth table, shown in FIG. 24, gives shift sequence of transmission of FIG. 23 and ratio steps between adjacent drive ratios.

When a forward speed is accomplished, main clutch 609C0 is always engaged. In addition, the following synchronizer engagements are applied. The first forward speed ratio is established by engagement of synchronizers 609S3 and 609S6. This results in gearwheel 609G1 driving linked gearwheels 609G2 and 609G2a. Since 609G2a drives 609G3 and 609G3 is linked with 609G6 through the engaged synchronizer 609S6, 609G5a is driven by 609G6 to provide first forward speed at the output shaft 609A2. The second forward speed ratio is established by engagement of synchronizer 609S5 and 609S6. This also results in gearwheel 609G1 driving linked gearwheels 609G2 and 609G2a. Since 609G2a drives 609G3 and 609G3 is linked with 609G9 through the engaged synchronizer 609S5, 609G8 is driven by 609G9 to provide the second forward speed at the output shaft 609A2. The third forward speed ratio is established by engagement of synchronizers 609S2 and 609S3. This results in 609G4 driving 609G5 to give third forward speed at the output shaft 609A2. The fourth forward speed ratio is established by engagement of synchronizer 609S4 only. This results in 609G1 driving 609G2 to give fourth speed at the output shaft 609A2. The fifth forward speed ratio is established by engagement of synchronizer 609S1 and 609S5. This results in 609G4 driving 609G6 through the idler 609G5. Since 609G6 is interconnected with 609G9 through the engaged synchronizer 609S5, 609G8a is driven by 609G9 to give fifth speed at the output shaft 609A2. The sixth forward speed ratio is established by engagement of synchronizer 609S1 only. This results in 609G7 driving 609G8 to give the sixth speed at the output shaft 609A2. The reverse speed ratio is established by engagement of synchronizer 609SR. This results in 609G1 driving 609G2 and 609G2a driving 609G3. Since 609G3 and 609GR1 are interconnected through the engaged synchronizer 609SR, 609GR1 drives 609GR2 through idler 609GI to give a reverse speed at the output shaft 609A2.

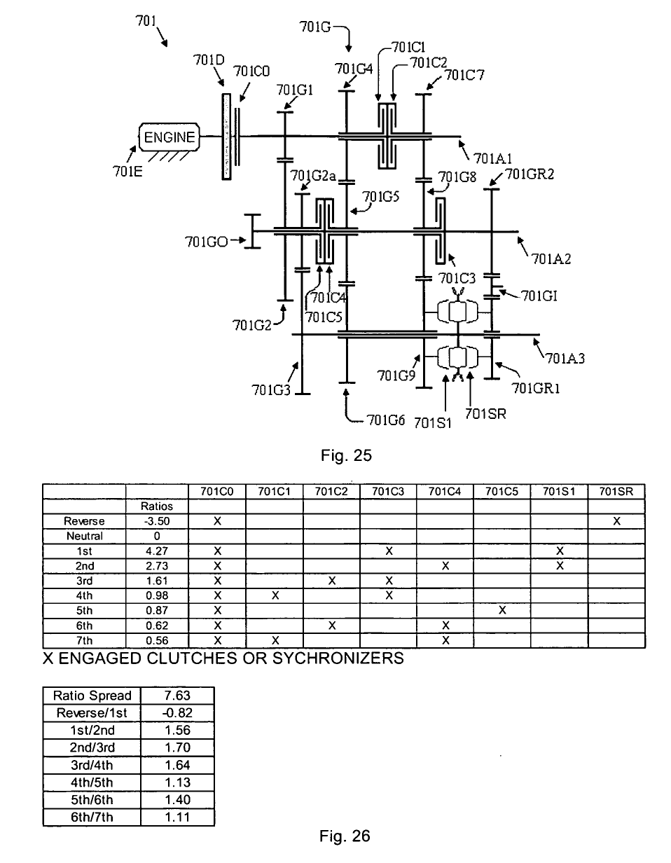

A powertrain system 701, shown in FIG. 25, has a conventional engine 701E and a seven-speed transmission gearbox 701G using ten forward driving gearwheels.

The seven-speed transmission gearbox 701G includes a mechanical damper 701D, which has connection between a main clutch 701C0 and an input shaft 701A1. 701G also includes forward driving gearwheels 701G1 and 701G3, which are fixed on the input shaft 701A1 and the intermediate shaft 701A3, respectively. Two linked forward driving gearwheel 701G2 and 701G2a are free to rotate on the output shaft 701A2 to serve as an idler. The forward driving gearwheels 701G4, 701G5, 701G6, 701G7, 701G8 and 701G9 are free to rotate on input shaft 701A1, the output shaft 701A2, which has a fixed output gearwheel 701GO to transmit torque to a final drive(not shown), and an intermediate shaft 701A3, respectively. They are also selectively interconnected with input shaft 701A1, output shaft 701A2 and intermediate shaft 701A3 by clutches 701C1, 701C2, 701C3, 701C4, 701C5 and synchronizer 604S1, respectively. 701G6 and 701G9 are linked and the synchronizer 701S1 is fixed on the intermediate shaft 701A3 and selectively interconnected with the linked 701G6 and 701G9. The clutches 701C1 and 701C2 allow 701G4 and 701G7 to be selectively interconnected on the input shaft 701A1 and the clutches 701C3 and 701C4 allow 701G5 and 701G8 to be selectively interconnected on the output shaft 701A2, respectively. 701G also has a reverse gearwheel 701GR1 which is free to rotate on the intermediate shaft 701A3 and selectively interconnected with the intermediate shaft 701A3 through synchronizer 701SR, gearwheel 701GR2 which is fixed on output shaft 701A2 and 701GI which serves as an idler to enable 701A2 in the same rotating direction of 701A1. The engagement and disengagement of the clutches are controlled by conventional electro-hydraulic mechanism, not shown, which includes a programmable digital computer. Such control mechanisms are well known to those skilled in the art.

A static truth table, shown in FIG. 26, gives shift sequence of transmission of FIG. 25 and ratio steps between adjacent drive ratios.

When a forward speed is accomplished, main clutch 701C0 is always engaged. In addition, the following clutch and synchronizer engagements are applied. The first forward speed ratio is established by engagement of clutches 701C3 and 701S1. This results in gearwheel 701G1 driving gearwheel 701G3 through the linked idlers 701G2 and 701G2a. Since 701G3 is linked to 701G9 by the synchronizer 701S1, 701G8 is driven by 701G9 to provide the first forward speed at the output shaft 701A2. The second forward speed ratio is established by engagement of the synchronizer 701S1 and the clutch 701C4. This results in gearwheel 701G1 driving gearwheel 701G3 through the linked idlers 701G2 and 701G2a. Since 701G3 is linked to 701G6 by the synchronizer 701S1, 701G5 is driven by 701G6 to provide the second forward speed at the output shaft 701A2. The third forward speed ratio is established by engagement of clutches 701C2 and 701C3. This results in 701G7 driving 701G8 to give third speed at the output shaft 701A2. The fourth forward speed ratio is established by engagement of clutches 701C1 and 701C3. This results in 701G4 driving 701G6 through the idler 701G5. Since 701G6 and 701G9 are linked, 701G8 is driven by 701G9 to give fourth forward speed at the output shaft 701A2. The fifth forward speed ratio is established by engagement of clutch 701C5 only. This results in gearwheel 701G1 driving gearwheel 701G2 to give fifth speed at the output shaft 701A2. The sixth forward speed ratio is established by engagement of clutches 701C2 and 701C4. This results in 701G7 driving 701G9 through the idler 701G8. Since 701G6 and 701G9 are linked, 701G5 is driven by 701G6 to give sixth speed at the output shaft 701A2. The seventh forward speed ratio is established by engagement of clutches 701C1 and 701C4. This results in 701G4 driving 701G5 to give the seventh speed at the output shaft 701A2. The reverse speed ratio is established by engagement of synchronizer 701SR. This results in 701G1 driving 701G3 through the idler 701G2. Since 701G3 and 701GR1 are linked through the engaged synchronizer 701SR, 701GR1 drives 701GR2 through idler 701GI to give a reverse speed at the output shaft 701A2.

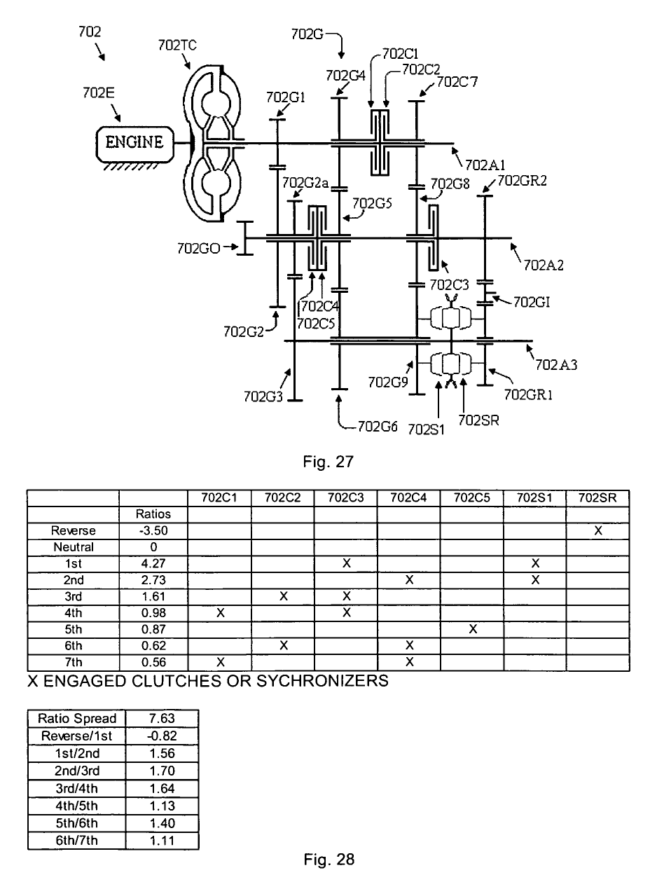

A powertrain system 702, shown in FIG. 27, has a conventional engine 702E and a seven-speed transmission gearbox 702G using ten forward driving gearwheels.

The seven-speed transmission gearbox 702G includes a torque converter 602TC to be connected to an input shaft 602A1. 702G also includes forward driving gearwheels 702G1 and 702G3, which are fixed on the input shaft 702A1 and the intermediate shaft 702A3, respectively. Two linked forward driving gearwheel 702G2 and 702G2a are free to rotate on the output shaft 702A2 to serve as an idler. The forward driving gearwheels 702G4, 702G5, 702G6, 702G7, 702G8 and 702G9 are free to rotate on input shaft 702A1, the output shaft 702A2, which has a fixed output gearwheel 702GO to transmit torque to a final drive(not shown), and an intermediate shaft 702A3, respectively. They are also selectively interconnected with input shaft 702A1, output shaft 702A2 and intermediate shaft 702A3 by clutches 702C1, 702C2, 702C3, 702C4, 702C5 and synchronizer 604S1, respectively. 702G6 and 702G9 are linked and the synchronizer 702S1 is fixed on the intermediate shaft 702A3 and selectively interconnected with the linked 702G6 and 702G9. The clutches 702C1 and 702C2 allow 702G4 and 702G7 to be selectively interconnected on the input shaft 702A1 and the clutches 702C3 and 702C4 allow 702G5 and 702G8 to be selectively interconnected on the output shaft 702A2, respectively. 702G also has a reverse gearwheel 702GR1 which is free to rotate on the intermediate shaft 702A3 and selectively interconnected with the intermediate shaft 702A3 through synchronizer 702SR, gearwheel 702GR2 which is fixed on output shaft 702A2 and 702GI which serves as an idler to enable 702A2 in the same rotating direction of 702A1. The engagement and disengagement of the clutches are controlled by conventional electro-hydraulic mechanism, not shown, which includes a programmable digital computer. Such control mechanisms are well known to those skilled in the art.

A static truth table, shown in FIG. 28, gives shift sequence of transmission of FIG. 27 and ratio steps between adjacent drive ratios.

When a forward speed is accomplished, the following clutch and synchronizer engagements are applied. The first forward speed ratio is established by engagement of clutches 702C3 and 702S1. This results in gearwheel 702G1 driving gearwheel 702G3 through the linked idlers 702G2 and 702G2a. Since 702G3 is linked to 702G9 by the synchronizer 702S1, 702G8 is driven by 702G9 to provide the first forward speed at the output shaft 702A2. The second forward speed ratio is established by engagement of the synchronizer 702S1 and the clutch 702C4. This results in gearwheel 702G1 driving gearwheel 702G3 through the linked idlers 702G2 and 702G2a. Since 702G3 is linked to 702G6 by the synchronizer 702S1, 702G5 is driven by 702G6 to provide the second forward speed at the output shaft 702A2. The third forward speed ratio is established by engagement of clutches 702C2 and 702C3. This results in 702G7 driving 702G8 to give third speed at the output shaft 702A2. The fourth forward speed ratio is established by engagement of clutches 702C1 and 702C3. This results in 702G4 driving 702G6 through the idler 702G5. Since 702G6 and 702G9 are linked, 702G8 is driven by 702G9 to give fourth forward speed at the output shaft 702A2. The fifth forward speed ratio is established by engagement of clutch 702C5 only. This results in gearwheel 702G1 driving gearwheel 702G2 to give fifth speed at the output shaft 702A2. The sixth forward speed ratio is established by engagement of clutches 702C2 and 702C4. This results in 702G7 driving 702G9 through the idler 702G8. Since 702G6 and 702G9 are linked, 702G5 is driven by 702G6 to give sixth speed at the output shaft 702A2. The seventh forward speed ratio is established by engagement of clutches 702C1 and 702C4. This results in 702G4 driving 702G5 to give the seventh speed at the output shaft 702A2. The reverse speed ratio is established by engagement of synchronizer 702SR. This results in 702G1 driving 702G3 through the idler 702G2. Since 702G3 and 702GR1 are linked through the engaged synchronizer 702SR, 702GR1 drives 702GR2 through idler 702GI to give a reverse speed at the output shaft 702A2.

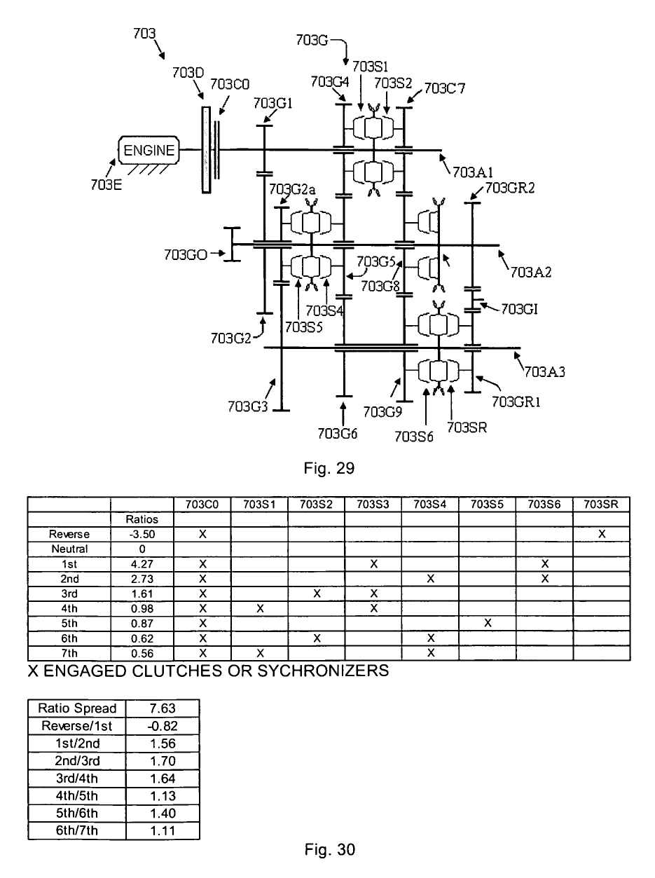

A powertrain system 703, shown in FIG. 29, has a conventional engine 703E and a seven-speed transmission gearbox 703G using ten forward driving gearwheels.

The seven-speed transmission gearbox 703G includes a mechanical damper 703D and a main clutch 703C0 to be connected to an input shaft 703A1. 703G also includes forward driving gearwheels 703G1 and 703G3, which are fixed on the input shaft 703A1 and the intermediate shaft 703A3, respectively. Two linked forward driving gearwheel 703G2 and 703G2a are free to rotate on the output shaft 703A2 to serve as an idler. The forward driving gearwheels 703G4, 703G5, 703G6, 703G7, 703G8 and 703G9 are free to rotate on input shaft 703A1, the output shaft 703A2, which has a fixed output gearwheel 703GO to transmit torque to a final drive(not shown), and an intermediate shaft 703A3, respectively. They are also selectively interconnected with input shaft 703A1, output shaft 703A2 and intermediate shaft 703A3 by synchronizers 703S1, 703S2, 703S3, 703S4, 703S5 and 604S6, respectively. 703G6 and 703G9 are linked and the synchronizer 703S6 is fixed on the intermediate shaft 703A3 and selectively interconnected with the linked 703G6 and 703G9. The synchronizers 703S1 and 703S2 allow 703G4 and 703G7 to be selectively interconnected on the input shaft 703A1 and the synchronizers 703S3 and 703S4 allow 703G5 and 703G8 to be selectively interconnected on the output shaft 703A2, respectively. 703G also has a reverse gearwheel 703GR1 which is free to rotate on the intermediate shaft 703A3 and selectively interconnected with the intermediate shaft 703A3 through synchronizer 703SR, gearwheel 703GR2 which is fixed on output shaft 703A2 and 703GI which serves as an idler to enable 703A2 in the same rotating direction of 703A1. The engagement and disengagement of the synchronizers are controlled by conventional electro-hydraulic mechanism, not shown, which includes a programmable digital computer. Such control mechanisms are well known to those skilled in the art.

A static truth table, shown in FIG. 30, gives shift sequence of transmission of FIG. 29 and ratio steps between adjacent drive ratios.

When a forward speed is accomplished, the following synchronizer and synchronizer engagements are applied. The first forward speed ratio is established by engagement of synchronizers 703S3 and 703S6. This results in gearwheel 703G1 driving gearwheel 703G3 through the linked idlers 703G2 and 703G2a. Since 703G3 is linked to 703G9 by the synchronizer 703S6, 703G8 is driven by 703G9 to provide the first forward speed at the output shaft 703A2. The second forward speed ratio is established by engagement of the synchronizers 703S6 and 703S4. This results in gearwheel 703G1 driving gearwheel 703G3 through the linked idlers 703G2 and 703G2a. Since 703G3 is linked to 703G6 by the synchronizer 703S6, 703G5 is driven by 703G6 to provide the second forward speed at the output shaft 703A2. The third forward speed ratio is established by engagement of synchronizers 703S2 and 703S3. This results in 703G7 driving 703G8 to give third speed at the output shaft 703A2. The fourth forward speed ratio is established by engagement of synchronizers 703S1 and 703S3. This results in 703G4 driving 703G6 through the idler 703G5. Since 703G6 and 703G9 are linked, 703G8 is driven by 703G9 to give fourth speed at the output shaft 703A2. The fifth forward speed ratio is established by engagement of synchronizers 703S5 only. This results in 703G1 driving 703G2 to give fifth speed at the output shaft 703A2. The sixth forward speed ratio is established by engagement of synchronizers 703S2 and 703S4. This results in 703G7 driving 703G9 through the idler 703G8. Since 703G6 and 703G9 are linked, 703G5 is driven by 703G6 to give sixth speed at the output shaft 703A2. The seventh forward speed ratio is established by engagement of synchronizers 703S1 and 703S4. This results in 703G4 driving 703G5 to give the seventh speed at the output shaft 703A2. The reverse speed ratio is established by engagement of synchronizer 703SR. This results in 703G1 driving 703G3 through the idler 703G2. Since 703G3 and 703GR1 are linked through the engaged synchronizer 703SR, 703GR1 drives 703GR2 through idler 703GI to give a reverse speed at the output shaft 703A2.

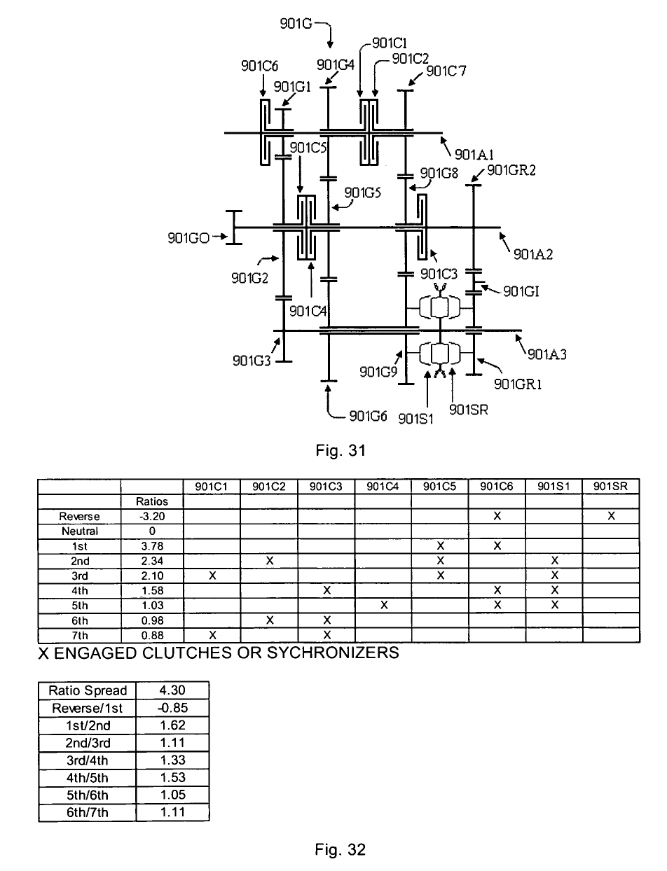

A transmission gearbox 901G, shown in FIG. 31, uses nine forward driving gearwheels for seven, eight and nine speeds. 901G are driven by a conventional engine through either a torque converter, not shown, or through a mechanical damper with a main clutch, not shown, to the input shaft 901A1.

The transmission gearbox 901G for seven, eight and nine speeds includes forward driving gearwheels, 901G1, 901G4 and 901G7 which are free to rotate on the input shaft 901A1, 901G2, 901G5 and 901G8 which are free to rotate on the output shaft 901A2, and 901G3, which is fixed on the intermediate shaft 901A3. 901G2 is selectively interconnected with the output shaft 901A2 by clutch 901C5. The forward driving gearwheels 901G1, 901G4 and 901G7 are selectively interconnected with input shaft 901A1 by clutches 901C1, 901C2 and 901C6, respectively. 901G5 and 901G8 are selectively interconnected with output shaft 901A2 by clutches 901C4 and 901C3, respectively. 901G6 and 901G9 are linked and the synchronizer 901S1 is fixed on the intermediate shaft 901A3. The linked 901G6 and 901G9 are selectively interconnected with intermediate shaft 901A3 by synchronizer 901S1. 901G also has reverse gearwheel 901GR1 which is free to rotate and selectively interconnected with the intermediate shaft 901A3 through synchronizer 901SR, gearwheel 901GR2 which is fixed on output shaft 901A2 and 901GI which serves as an idler to provide the same rotating direction of 901A1. The engagement and disengagement of the clutches are controlled by conventional electro-hydraulic mechanism, not shown, which includes a programmable digital computer. Such control mechanisms are well known to those skilled in the art.

A static truth table, shown in FIG. 32, gives shift sequence of seven-speed transmission gearbox of FIG. 31 and ratio steps between adjacent drive ratios.

When a forward speed is accomplished, the following clutch and synchronizer engagements are applied. The first forward speed ratio is established by engagement of clutches 901C5 and 901C6. This results in gearwheel 901G1 driving linked gearwheels 901G2 to provide the first forward speed at the output shaft 901A2. The second forward speed ratio is established by engagement of clutches 901C2, 901C5 and synchronizer 901S1. This also results in gearwheel 901G7 driving 901G9 through the idler 901G8. Since 901G9 and 901G3 are interconnected through the engagement of synchronizer 901S1, 901G2 is driven by 901G3 to provide the second forward speed at the output shaft 901A2. The third forward speed ratio is established by the engagement of clutches 901C1, 901C5 and synchronizer 901S1. This results in 901G4 driving 901G6 through the idler 901G5. Since 901G6 and 901G3 are interconnected through the engagement of synchronizer 901S1, 901G2 is driven by 901G3 to provide the third forward speed at the output shaft 901A2. The fourth forward speed ratio is established by engagement of clutches 901C3, 901C6 and synchronizer 901S1. This results in 901G1 driving 901G3 through the idler 901G2. Since 901G9 and 901G3 are interconnected through the engagement of synchronizer 901S1, 901G8 is driven by 901G9 to provide the fourth forward speed at the output shaft 901A2. The fifth forward speed ratio is established by engagement of clutches 901C4, 901C6 and synchronizer 901S1. This results in 901G1 driving 901G3 through the idler 901G2. Since 901G6 and 901G3 are interconnected through the engagement of synchronizer 901S1, 901G5 is driven by 901G6 to provide the fifth forward speed at the output shaft 901A2. The sixth forward speed ratio is established by engagement of clutches 901C2 and 901C3. This results in 901G7 driving 901G8 to give the sixth speed at the output shaft 901A2. After shifting from fifth to sixth gears, or shifting from sixth to fifth gears, the synchronizer 901S1's engagement and disengagement do not affect the resulting gear ratio. The seventh forward speed ratio is established by engagement of clutches 901C1 and 901C3. Since 901G4 drives 901G6 through the idler 901G5 and 901G9 is linked with 901G6, 901G8 is driven by 901G9 to provide seventh forward speed at the output shaft 901A2. The reverse speed ratio is established by engagement of synchronizer 901SR. This results in 901G1 driving 901G2 and 901G2a driving 901G3. Since 901G3 and 901GR1 are interconnected through the engaged synchronizer 901SR, 901GR1 drives 901GR2 through idler 901G1 to give a reverse speed at the output shaft 901A2.

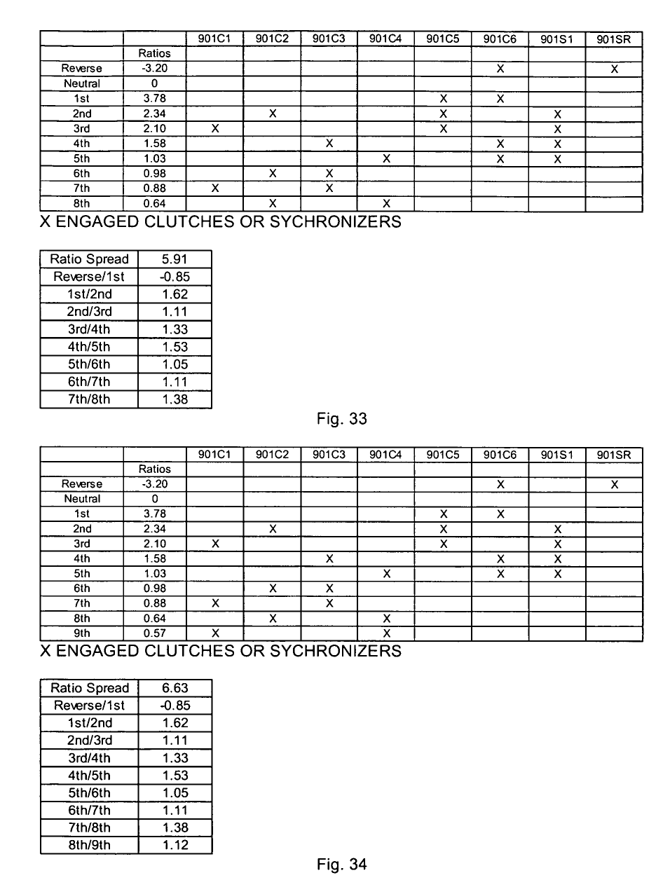

A static truth table, shown in FIG. 33, gives shift sequence of eight-speed transmission gearbox of FIG. 31 and ratio steps between adjacent drive ratios.

When a forward speed is accomplished for eight-speed transmission gearbox, the following clutch and synchronizer engagements are applied. The first forward speed ratio is established by engagement of clutches 901C5 and 901C6. This results in gearwheel 901G1 driving linked gearwheels 901G2 to provide the first forward speed at the output shaft 901A2. The second forward speed ratio is established by engagement of clutches 901C2, 901C5 and synchronizer 901S1. This also results in gearwheel 901G7 driving 901G9 through the idler 901G8. Since 901G9 and 901G3 are interconnected through the engagement of synchronizer 901S1, 901G2 is driven by 901G3 to provide the second forward speed at the output shaft 901A2. The third forward speed ratio is established by the engagement of clutches 901C1, 901C5 and synchronizer 901S1. This results in 901G4 driving 901G6 through the idler 901G5. Since 901G6 and 901G3 are interconnected through the engagement of synchronizer 901S1, 901G2 is driven by 901G3 to provide the third forward speed at the output shaft 901A2. The fourth forward speed ratio is established by engagement of clutches 901C3, 901C6 and synchronizer 901S1. This results in 901G1 driving 901G3 through the idler 901G2. Since 901G9 and 901G3 are interconnected through the engagement of synchronizer 901S1, 901G8 is driven by 901G9 to provide the fourth forward speed at the output shaft 901A2. The fifth forward speed ratio is established by engagement of clutches 901C4, 901C6 and synchronizer 901S1. This results in 901G1 driving 901G3 through the idler 901G2. Since 901G6 and 901G3 are interconnected through the engagement of synchronizer 901S1, 901G5 is driven by 901G6 to provide the fifth forward speed at the output shaft 901A2. The sixth forward speed ratio is established by engagement of clutches 901C2 and 901C3. This results in 901G7 driving 901G8 to give the sixth speed at the output shaft 901A2. After shifting from fifth to sixth gears, or shifting from sixth to fifth gears, the synchronizer 901S1's engagement or disengagement do not affect the resulting gear ratio. The seventh forward speed ratio is established by engagement of clutches 901C1 and 901C3. Since 901G4 drives 901G6 through the idler 901G5 and 901G9 is linked with 901G6, 901G8 is driven by 901G9 to provide seventh forward speed at the output shaft 901A2. The eighth forward speed ratio established by engagement of clutches 901C2 and 901C4. This results in 901G7 driving 901G9 through the idler 901G8. Since 901G6 and 901G9 are linked, 901G5 is driven by 901G6 to provide eighth forward speed at the output shaft 901A2. The reverse speed ratio is established by engagement of synchronizer 901SR. This results in 901G1 driving 901G2 and 901G2a driving 901G3. Since 901G3 and 901GR1 are interconnected through the engaged synchronizer 901SR, 901GR1 drives 901GR2 through idler 901GI to give a reverse speed at the output shaft 901A2.

A static truth table, shown in FIG. 34, gives shift sequence of nine-speed transmission gearbox of FIG. 31 and ratio steps between adjacent drive ratios.

When a forward speed is accomplished for nine-speed transmission gearbox, the following clutch and synchronizer engagements are applied. The first forward speed ratio is established by engagement of clutches 901C5 and 901C6. This results in gearwheel 901G1 driving linked gearwheels 901G2 to provide the first forward speed at the output shaft 901A2. The second forward speed ratio is established by engagement of clutches 901C2, 901C5 and synchronizer 901S1. This also results in gearwheel 901G7 driving 901G9 through the idler 901G8. Since 901G9 and 901G3 are interconnected through the engagement of synchronizer 901S1, 901G2 is driven by 901G3 to provide the second forward speed at the output shaft 901A2. The third forward speed ratio is established by the engagement of clutches 901C1, 901C5 and synchronizer 901S1. This results in 901G4 driving 901G6 through the idler 901G5. Since 901G6 and 901G3 are interconnected through the engagement of synchronizer 901S1, 901G2 is driven by 901G3 to provide the third forward speed at the output shaft 901A2. The fourth forward speed ratio is established by engagement of clutches 901C3, 901C6 and synchronizer 901S1. This results in 901G1 driving 901G3 through the idler 901G2. Since 901G9 and 901G3 are interconnected through the engagement of synchronizer 901S1, 901G8 is driven by 901G9 to provide the fourth forward speed at the output shaft 901A2. The fifth forward speed ratio is established by engagement of clutches 901C4, 901C6 and synchronizer 901S1. This results in 901G1 driving 901G3 through the idler 901G2. Since 901G6 and 901G3 are interconnected through the engagement of synchronizer 901S1, 901G5 is driven by 901G6 to provide the fifth forward speed at the output shaft 901A2. The sixth forward speed ratio is established by engagement of clutches 901C2 and 901C3. This results in 901G7 driving 901G8 to give the sixth speed at the output shaft 901A2. After shifting from fifth to sixth gears, or shifting from sixth to fifth gears, the synchronizer 901S1's engagement or disengagement do not affect the resulting gear ratio. The seventh forward speed ratio is established by engagement of clutches 901C1 and 901C3. Since 901G4 drives 901G6 through the idler 901G5 and 901G9 is linked with 901G6, 901G8 is driven by 901G9 to provide seventh forward speed at the output shaft 901A2. The eighth forward speed ratio established by engagement of clutches 901C2 and 901C4. This results in 901G7 driving 901G9 through the idler 901G8. Since 901G6 and 901G9 are linked, 901G5 is driven by 901G6 to provide eighth forward speed at the output shaft 901A2. The ninth forward speed ratio established by engagement of clutches 901C1 and 901C4. This results in 901G4 driving 901G5 to provide ninth forward speed at the output shaft 901A2. The reverse speed ratio is established by engagement of synchronizer 901SR. This results in 901G1 driving 901G2 and 901G2a driving 901G3. Since 901G3 and 901GR1 are interconnected through the engaged synchronizer 901SR, 901GR1 drives 901GR2 through idler 901GI to give a reverse speed at the output shaft 901A2.

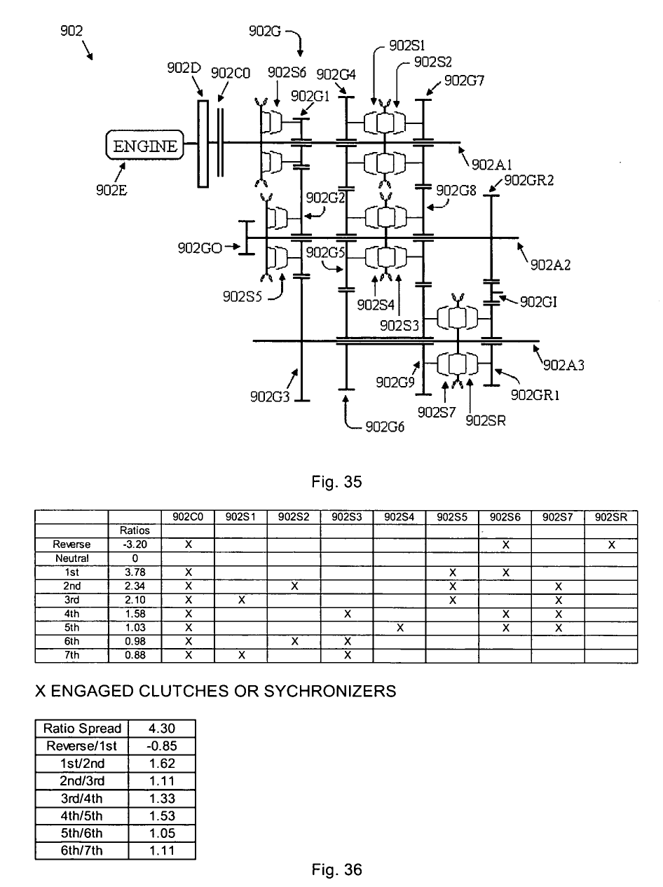

A powertrain system 902 with a transmission gearbox 902G, shown in FIG. 35, uses nine forward driving gearwheels for seven, eight and nine speeds. 902G is driven by a conventional engine through a mechanical damper 902D with a main clutch 902C0 to the input shaft 902A1.

The clutches are replaced with synchronizers as torque transmitting mechanisms in the transmission gearbox 901G in FIG. 31 to become automated manual transmission gearbox 902G, shown in FIG. 35. 902G is driven by a conventional engine 902E through a mechanical damper 902D with a main clutch 902C0 to the input shaft 902A1.

A static truth table, shown in FIG. 36, gives shift sequence of seven-speed transmission gearbox of FIG. 35 and ratio steps between adjacent drive ratios.

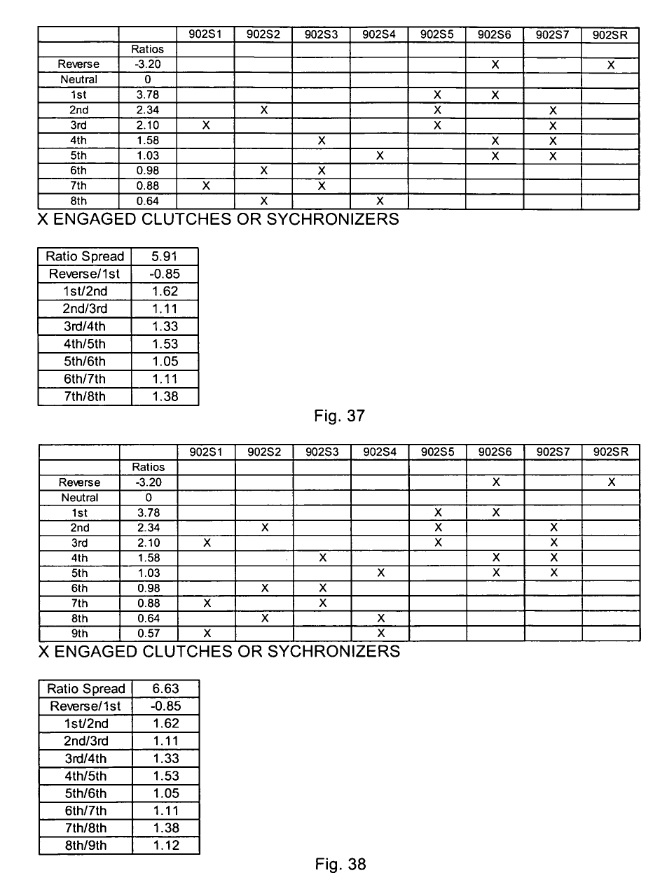

A static truth table, shown in FIG. 37, gives shift sequence of eight-speed transmission gearbox of FIG. 35 and ratio steps between adjacent drive ratios.

A static truth table, shown in FIG. 38, gives shift sequence of nine-speed transmission gearbox of FIG. 35 and ratio steps between adjacent drive ratios.

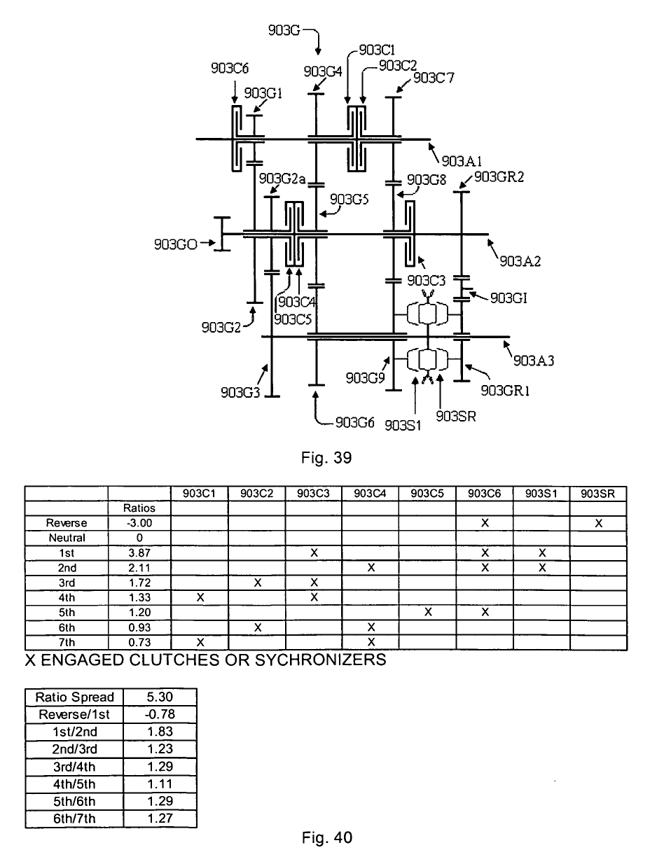

A transmission gearbox 903G, shown in FIG. 39, uses ten forward driving gearwheels for seven, eight and nine speeds. 903G are driven by a conventional engine through a torque converter, not shown, or through a mechanical damper with a main clutch, not shown, to the input shaft 903A1.

The transmission gearbox 903G for seven, eight and nine speeds includes forward driving gearwheels, 903G1, 903G4 and 903G7 which are free to rotate on the input shaft 903A1, 903G2, 903G2a, 903G5 and 903G8 which are free to rotate on the output shaft 903A2, and 903G3, which is fixed on the intermediate shaft 903A3. 903G2 and 903G2a are linked and are selectively interconnected with the output shaft 903A2 by clutch 903C5. The forward driving gearwheels 903G1, 903G4 and 903G7 are selectively interconnected with input shaft 903A1 by clutches 903C1, 903C2 and 903C6, respectively. 903G5 and 903G8 are selectively interconnected with output shaft 903A2 by clutches 903C4 and 903C3, respectively. 903G6 and 903G9 are linked and the synchronizer 903S1 is fixed on the intermediate shaft 903A3. The linked 903G6 and 903G9 are selectively interconnected with intermediate shaft 903A3 by synchronizer 903S1. 903G also has reverse gearwheel 903GR1 which is free to rotate and selectively interconnected with the intermediate shaft 903A3 through synchronizer 903SR, gearwheel 903GR2 which is fixed on output shaft 903A2 and 903GI which serves as an idler to provide the same rotating direction of 903A1. The engagement and disengagement of the clutches are controlled by conventional electro-hydraulic mechanism, not shown, which includes a programmable digital computer. Such control mechanisms are well known to those skilled in the art.

A static truth table, shown in FIG. 40, gives shift sequence of seven-speed transmission gearbox of FIG. 39 and ratio steps between adjacent drive ratios.

When a forward speed is accomplished, the following clutch and synchronizer engagements are applied. The first forward speed ratio is established by engagement of clutches 903C3, 903C6 and 903S1. This results in gearwheel 903G1 driving linked gearwheels 903G2 and 903G2a. Since 903G2a drives 903G3 and 903G3 is interconnected with 903G9 through synchronizer 903S1, 903G8 is driven by 903G9 to provide first forward speed at the output shaft 903A2. The second forward speed ratio is established by engagement of clutches 903C4, 903C6 and synchronizer 903S1. This also results in gearwheel 903G1 driving linked gearwheels 903G2 and 903G2a. Since 903G2a drives 903G3 and 903G3 is interconnected with 903G6 through clutches 903C2 and 903C3, 903G5 is driven by 903G6 to provide the second forward speed at the output shaft 903A2. The third forward speed ratio is established by engagement of clutches 903C2 and 903C3. This results in 903G7 driving 903G8 to give the third forward speed at the output shaft 903A2. After shifting from second to third gear or from third to second gear, the synchronizer 903S1's engagement or disengagement do not affect the resulting gear ratio. The fourth forward speed ratio is established by engagement of clutches 903C1 and 903C3. Since 903G4 drives 903G6 through the idler 903G5 and 903G9 and 903G6 are linked, 903G8 is driven by 903G9 to provide fourth forward speed at the output shaft 903A2. The fifth forward speed ratio is established by engagement of clutches 903C5 and 903C6. This results in 903G1 driving 903G2 to give fifth speed at the output shaft 903A2. The sixth forward speed ratio is established by engagement of clutches 903C2 and 903C4. This results in 903G7 driving 903G9 through the idler 903G8. Since 903G9 and 903G6 are linked, 903G5 is driven by 903G6 to give the sixth speed at the output shaft 903A2. The seventh forward speed ratio is established by engagement of clutches 903C1 and 903C4. This results in 903G4 driving 903G5 to provide seventh forward speed at the output shaft 903A2. The reverse speed ratio is established by engagement of synchronizer 903SR. This results in 903G1 driving 903G2 and 903G2a driving 903G3. Since 903G3 and 903GR1 are interconnected through the engaged synchronizer 903SR, 903GR1 drives 903GR2 through idler 903GI to give a reverse speed at the output shaft 903A2.

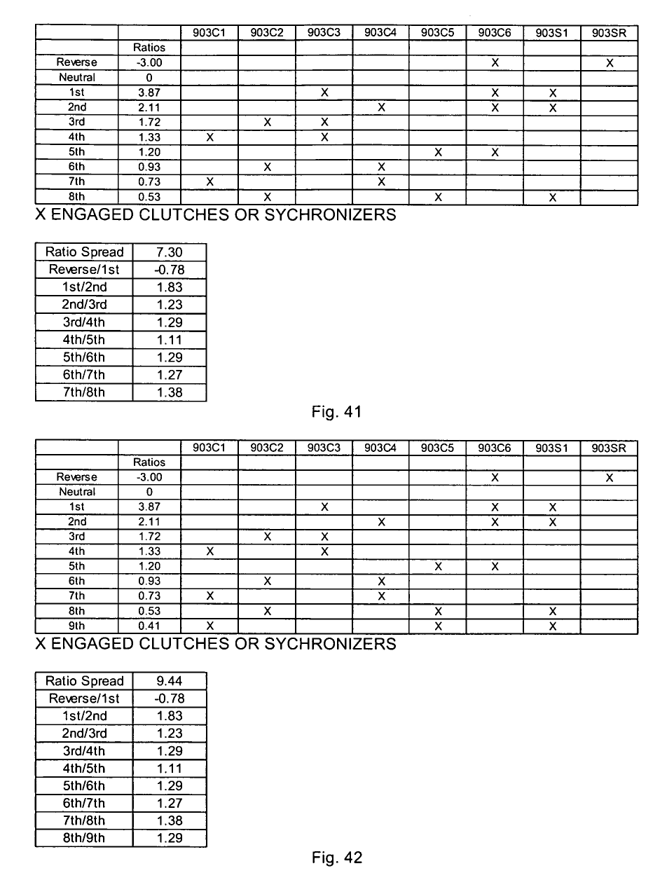

A static truth table, shown in FIG. 41, gives shift sequence of eight-speed transmission gearbox of FIG. 39 and ratio steps between adjacent drive ratios.

When a forward speed is accomplished, the following clutch and synchronizer engagements are applied. The first forward speed ratio is established by engagement of clutches 903C3, 903C6 and 903S1. This results in gearwheel 903G1 driving linked gearwheels 903G2 and 903G2a. Since 903G2a drives 903G3 and 903G3 is interconnected with 903G9 through synchronizer 903S1, 903G8 is driven by 903G9 to provide first forward speed at the output shaft 903A2. The second forward speed ratio is established by engagement of clutches 903C4, 903C6 and synchronizer 903S1. This also results in gearwheel 903G1 driving linked gearwheels 903G2 and 903G2a. Since 903G2a drives 903G3 and 903G3 is interconnected with 903G6 through clutches 903C2 and 903C3, 903G5 is driven by 903G6 to provide the second forward speed at the output shaft 903A2. The third forward speed ratio is established by engagement of clutches 903C2 and 903C3. This results in 903G7 driving 903G8 to give the third forward speed at the output shaft 903A2. After shifting from second to third gear or from third to second gear, the synchronizer 903S1's engagement or disengagement do not affect the resulting gear ratio. The fourth forward speed ratio is established by engagement of clutches 903C1 and 903C3. Since 903G4 drives 903G6 through the idler 903G5 and 903G9 and 903G6 are linked, 903G8 is driven by 903G9 to provide fourth forward speed at the output shaft 903A2. The fifth forward speed ratio is established by engagement of clutches 903C5 and 903C6. This results in 903G1 driving 903G2 to give fifth speed at the output shaft 903A2. The sixth forward speed ratio is established by engagement of clutches 903C2 and 903C4. This results in 903G7 driving 903G9 through the idler 903G8. Since 903G9 and 903G6 are linked, 903G5 is driven by 903G6 to give the sixth speed at the output shaft 903A2. The seventh forward speed ratio is established by engagement of clutches 903C1 and 903C4. This results in 903G4 driving 903G5 to provide seventh forward speed at the output shaft 903A2. The eighth forward speed ratio established by engagement of clutches 903C2 and 903C5 and synchronizer 903S1. This results in 903G7 driving 903G9 through the idler 903G8. Since 903G9 is interconnected with 903G3 through synchronizer 903S1, 903G2a is driven by 903G3 to provide eighth forward speed at the output shaft 903A2. The reverse speed ratio is established by engagement of synchronizer 903SR. This results in 903G1 driving 903G2 and 903G2a driving 903G3. Since 903G3 and 903GR1 are interconnected through the engaged synchronizer 903SR, 903GR1 drives 903GR2 through idler 903GI to give a reverse speed at the output shaft 903A2.

A static truth table, shown in FIG. 42, gives shift sequence of nine-speed transmission gearbox of FIG. 39 and ratio steps between adjacent drive ratios.

When a forward speed is accomplished, the following clutch and synchronizer engagements are applied. The first forward speed ratio is established by engagement of clutches 903C3, 903C6 and 903S1. This results in gearwheel 903G1 driving linked gearwheels 903G2 and 903G2a. Since 903G2a drives 903G3 and 903G3 is interconnected with 903G9 through synchronizer 903S1, 903G8 is driven by 903G9 to provide first forward speed at the output shaft 903A2. The second forward speed ratio is established by engagement of clutches 903C4, 903C6 and synchronizer 903S1. This also results in gearwheel 903G1 driving linked gearwheels 903G2 and 903G2a. Since 903G2a drives 903G3 and 903G3 is interconnected with 903G6 through clutches 903C2 and 903C3, 903G5 is driven by 903G6 to provide the second forward speed at the output shaft 903A2. The third forward speed ratio is established by engagement of clutches 903C2 and 903C3. This results in 903G7 driving 903G8 to give the third forward speed at the output shaft 903A2. After shifting from second to third gear or from third to second gear, the synchronizer 903S1's engagement or disengagement do not affect the resulting gear ratio. The fourth forward speed ratio is established by engagement of clutches 903C1 and 903C3. Since 903G4 drives 903G6 through the idler 903G5 and 903G9 and 903G6 are linked, 903G8 is driven by 903G9 to provide fourth forward speed at the output shaft 903A2. The fifth forward speed ratio is established by engagement of clutches 903C5 and 903C6. This results in 903G1 driving 903G2 to give fifth speed at the output shaft 903A2. The sixth forward speed ratio is established by engagement of clutches 903C2 and 903C4. This results in 903G7 driving 903G9 through the idler 903G8. Since 903G9 and 903G6 are linked, 903G5 is driven by 903G6 to give the sixth speed at the output shaft 903A2. The seventh forward speed ratio is established by engagement of clutches 903C1 and 903C4. This results in 903G4 driving 903G5 to provide seventh forward speed at the output shaft 903A2. The eighth forward speed ratio established by engagement of clutches 903C2 and 903C5 and synchronizer 903S1. This results in 903G7 driving 903G9 through the idler 903G8. Since 903G9 is interconnected with 903G3 through synchronizer 903S1, 903G2a is driven by 903G3 to provide eighth forward speed at the output shaft 903A2. The ninth forward speed ratio established by engagement of clutches 903C1 and 903C5 and synchronizer 903S1. This results in 903G4 driving 903G6 through the idler 903G5. Since 903G6 is interconnected with 903G3 through synchronizer 903S1, 903G2a is driven by 903G3 to provide ninth forward speed at the output shaft 903A2. The reverse speed ratio is established by engagement of synchronizer 903SR. This results in 903G1 driving 903G2 and 903G2a driving 903G3. Since 903G3 and 903GR1 are interconnected through the engaged synchronizer 903SR, 903GR1 drives 903GR2 through idler 903GI to give a reverse speed at the output shaft 903A2.

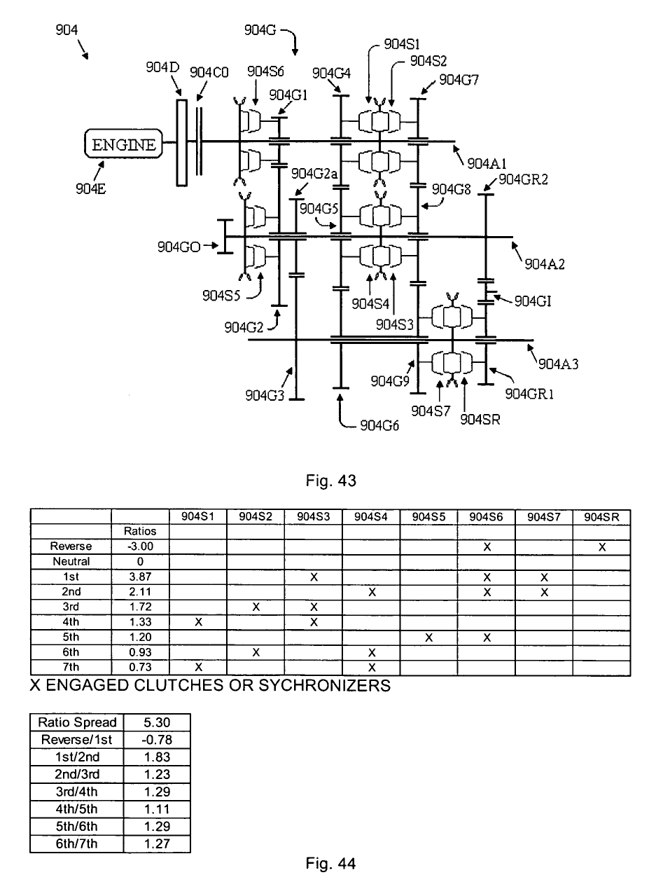

A powertrain system 904 with a transmission gearbox 904G, shown in FIG. 43, uses ten forward driving gearwheels for seven, eight and nine speeds. 904G is driven by a conventional engine through a mechanical damper 904D with a main clutch 904C0 to the input shaft 904A1.

The clutches are replaced with synchronizers as torque transmitting mechanisms in the transmission gearbox 903G in FIG. 39 to become automated manual transmission gearbox 904G, shown in FIG. 43. 904G is driven by a conventional engine 904E through a mechanical damper 904D with a main clutch 904C0 to the input shaft 904A1.

A static truth table, shown in FIG. 44, gives shift sequence of seven-speed transmission gearbox of FIG. 43 and ratio steps between adjacent drive ratios.

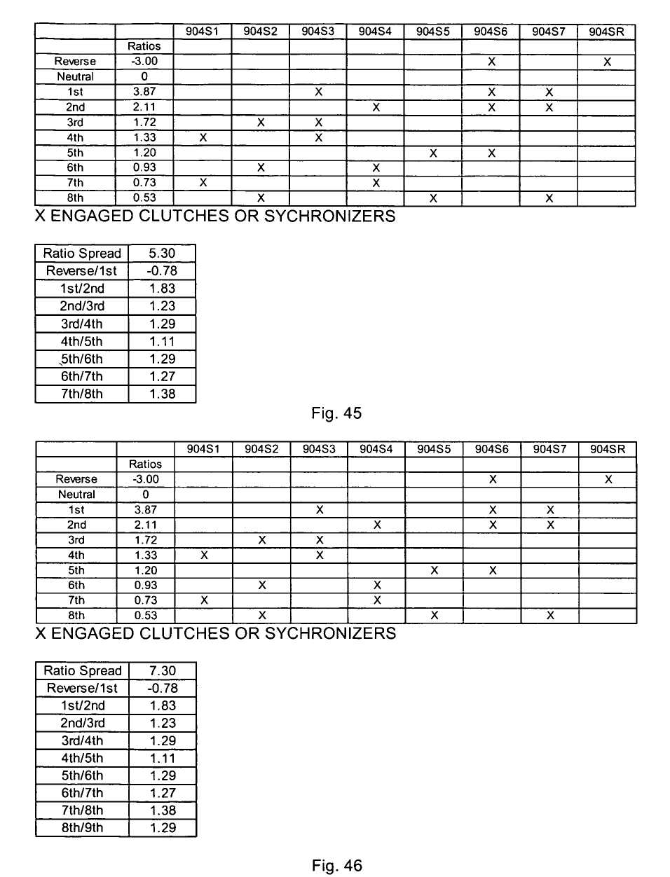

A static truth table, shown in FIG. 45, gives shift sequence of eight-speed transmission gearbox of FIG. 43 and ratio steps between adjacent drive ratios.

A static truth table, shown in FIG. 46, gives shift sequence of nine-speed transmission gearbox of FIG. 43 and ratio steps between adjacent drive ratios.

1. A multi-speed transmission gearbox, having three parallel shafts, comprising:
an input shaft;
an intermediate shaft adapted to rotate in synchronism with the said input shaft;
an output shaft, said input shaft and said intermediate shaft being disposed in parallel with one another;
a first torque transmitting mechanism provided on said input shaft;
a second torque transmitting mechanism provided on said input shaft;
a third torque transmitting mechanism provided on said output shaft;
a first gearwheel being continuously interconnected with said input shaft;
a second gearwheel being freely rotating on said output shaft;
a fourth gearwheel being selectively interconnected with said input shaft via said first torque transmitting mechanism;
a fifth gearwheel being selectively interconnected with said intermediate shaft via said third torque transmitting mechanism;
a seventh gearwheel being selectively interconnected with said input shaft via second torque transmitting mechanism;
an eighth gearwheel being freely rotating on said intermediate shaft;
an output gearwheel being continuously interconnected with said input shaft;
a reverse synchronizer provided on said intermediate shaft;
a first reverse gearwheel being selectively interconnected with said intermediate shaft via said reverse synchronizer;
a second reverse gearwheel, as an idler, being driven by said first said first reverse gearwheel;
a third reverse gearwheel provided on said output shaft;
said input shaft with either,
a mechanical damper with a main clutch interconnected with said input shaft, or
a torque converter with said input shaft;
said three parallel shafts with either,
In a five-speed transmission gearbox using eight gearwheels and six torque transmitting mechanisms for forward driving, a fourth torque transmitting mechanism provided on said output shaft, said second gearwheel being selectively interconnected with said output shaft via said fourth torque transmitting mechanism, a fifth torque transmitting mechanism provided on said output shaft, a sixth gearwheel being continuously interconnected with said intermediate shaft, said eighth gearwheel being selectively interconnected with said intermediate shaft via said fifth torque transmitting mechanism, a ninth gearwheel being continuously interconnected with said intermediate shaft, or
In a six-speed transmission gearbox using nine gearwheels and five torque transmitting mechanisms for forward driving, a fourth torque transmitting mechanism provided on said output shaft, a fifth torque transmitting mechanism as a synchronizer provided on said intermediate shaft, a third gearwheel being continuously interconnected with said intermediate shaft, said fifth gearwheel being selectively interconnected with said output shaft via said fourth torque transmitting mechanism, a sixth gearwheel provided on said intermediate shaft and being freely rotate on said intermediate shaft, a ninth gearwheel provided on said intermediate shaft being freely rotate on said intermediate shaft, said sixth and ninth gearwheels being continuously interconnected, said interconnected sixth and ninth gearwheels being selectively interconnected with said intermediate shaft via said fifth torque transmitting mechanism, said eighth gearwheel being selectively interconnected with said output shaft via said third torque transmitting mechanism, or
In a six-speed transmission gearbox using ten gearwheels and six torque transmitting mechanisms for forward driving, a fourth torque transmitting mechanism provided on said output shaft, a fifth torque transmitting mechanism provided on said intermediate shaft, a sixth torque transmitting mechanism as a synchronizer provided on said intermediate shaft, an additional gearwheel continuously interconnected with said second gearwheel, said interconnected said second gearwheel and said additional gearwheel being selectively interconnected with said output shaft via said fourth torque transmitting mechanism, a third gearwheel being continuously interconnected with said intermediate shaft, said fifth gearwheel being continuously interconnected with said output shaft, a sixth gearwheel provided on said intermediate shaft and being rotate freely, a ninth gearwheel provided on said intermediate shaft, ninth gearwheel being selectively interconnected with said intermediate shaft via said sixth torque transmitting mechanism, said sixth and ninth gearwheels being selectively interconnected via said fifth torque transmitting mechanism, said eighth gearwheel being selectively interconnected with said output shaft via said third torque transmitting mechanism, or
In a six-speed transmission gearbox using eleven gearwheels and six torque transmitting mechanisms for forward driving, a fourth torque transmitting mechanism provided on said output shaft, a fifth torque transmitting mechanism provided on said intermediate shaft, a sixth torque transmitting mechanism as a synchronizer provided on said intermediate shaft, a first additional gearwheel continuously interconnected with said second gearwheel, said interconnected said second gearwheel and said additional gearwheel being selectively interconnected with said output shaft via said fourth torque transmitting mechanism, a third gearwheel being continuously interconnected with said intermediate shaft, a second additional gearwheel being continuously interconnected with said fifth gearwheel, said interconnected fifth gearwheel and second additional gearwheel being continuously interconnected with said output shaft, a sixth gearwheel provided on said intermediate shaft and being rotate freely, a ninth gearwheel provided and being rotate freely on said intermediate shaft, said ninth gearwheel being selectively interconnected with said intermediate shaft via said sixth torque transmitting mechanism, said sixth and ninth gearwheels being selectively interconnected via said fifth torque transmitting mechanism, said eighth gearwheel being selectively interconnected with said output shaft via said third torque transmitting mechanism, or
In a seven-speed transmission gearbox using ten gearwheels and six torque transmitting mechanisms for forward driving, a fourth torque transmitting mechanism provided on said output shaft, a fifth torque transmitting mechanism provided on said output shaft, a sixth torque transmitting mechanism as a synchronizer provided on said intermediate shaft, an additional gearwheel continuously interconnected with said second gearwheel, said interconnected said second gearwheel and said additional gearwheel being selectively interconnected with said output shaft via said fifth torque transmitting mechanism, a third gearwheel being continuously interconnected with said intermediate shaft, said fifth gearwheel being selectively interconnected with said output shaft via fourth torque transmitting mechanism, a sixth gearwheel provided on said intermediate shaft and being rotating freely, a ninth gearwheel provided on said intermediate shaft and being rotating freely, said sixth and ninth gearwheels being continuously interconnected, said interconnected sixth and ninth gearwheels being selectively interconnected via said sixth torque transmitting mechanism, said eighth gearwheel being selectively interconnected with said output shaft via said third torque transmitting mechanism, or
In seven-speed, eight-speed and nine speed transmission gearboxes using nine gearwheels and seven torque transmitting mechanisms for forward driving, a fourth torque transmitting mechanism provided on said output shaft, a fifth torque transmitting mechanism provided on said output shaft, a sixth torque transmitting mechanism provided on said output shaft, a seventh torque transmitting mechanism as a synchronizer provided on said intermediate shaft, an additional gearwheel continuously interconnected with said second gearwheel, said interconnected said second gearwheel and said additional gearwheel being selectively interconnected with said output shaft via said fifth torque transmitting mechanism, a third gearwheel being continuously interconnected with said intermediate shaft, said fifth gearwheel being selectively interconnected with said output shaft via fourth torque transmitting mechanism, a sixth gearwheel provided on said intermediate shaft and being rotating freely, a ninth gearwheel provided on said intermediate shaft and being rotating freely, said sixth and ninth gearwheels being continuously interconnected, said interconnected sixth and ninth gearwheels being selectively interconnected via said sixth torque transmitting mechanism, said eighth gearwheel being selectively interconnected with said output shaft via said third torque transmitting mechanism, or
In seven-speed, eight-speed and nine speed transmission gearboxes using ten gearwheels and seven torque transmitting mechanisms for forward driving, a fourth torque transmitting mechanism provided on said output shaft, a fifth torque transmitting mechanism provided on said output shaft, a sixth torque transmitting mechanism provided on said output shaft, a seventh torque transmitting mechanism as a synchronizer provided on said intermediate shaft, said interconnected said second gearwheel and said additional gearwheel being selectively interconnected with said output shaft via said fifth torque transmitting mechanism, a third gearwheel being continuously interconnected with said intermediate shaft, said fifth gearwheel being selectively interconnected with said output shaft via fourth torque transmitting mechanism, a sixth gearwheel provided on said intermediate shaft and being rotating freely, a ninth gearwheel provided on said intermediate shaft and being rotating freely, said sixth and ninth gearwheels being continuously interconnected, said interconnected sixth and ninth gearwheels being selectively interconnected via said sixth torque transmitting mechanism, said eighth gearwheel being selectively interconnected with said output shaft via said third torque transmitting mechanism.

2. The transmission gearboxes defined in claim 1, wherein hydraulically controlled clutches are used in the places of said torque transmitting mechanisms, relative clutch slippery speed between driving and driven clutch pads is reduced during gear shifting from the first gear to the second gear by the claim 1 defined arrangement of gearwheels and torque transmitting mechanisms comparing to a dual-clutch transmission.

3. The transmission gearboxes defined in claim 1, wherein the consecutive shifting orders are specified for gear shifting from the first gear to fifth gear in five-speed transmission gearboxes, from the first gear to sixth gear in six-speed transmission gearboxes, from the first gear to seventh gear in seven-speed transmission gearboxes, from the first gear to eighth gear in eight-speed transmission gearboxes, and from the first gear to ninth gear in nine-speed transmission gearboxes.

4. The transmission gearboxes defined in claim 1, wherein said synchronizer is used with hydraulically controlled clutches in the places of torque transmitting mechanisms on said intermediate shaft to be shifted without causing torque interruption using the consecutive shifting orders defined in claim 3.

5. The five-speed transmission gearboxes using eight forward driving gearwheels defined in claim 1, wherein six of eight gearwheels for forward driving are used for more than one forward speed.

6. The six-speed transmission gearboxes using nine gearwheels for forward driving defined in claim 1, wherein each of nine gearwheels for forward driving is used for more than one forward speed.

7. The six-speed transmission gearboxes using ten gearwheels for forward driving defined in claim 1, wherein nine of ten gearwheels for forward driving are used for more than one forward speed.

8. The six-speed transmission gearboxes using eleven gearwheels for forward driving defined in claim 1, wherein ten of eleven gearwheels for forward driving are used for more than one forward speed.

9. The seven-speed transmission gearboxes using ten gearwheels for forward driving defined in claim 1, wherein each of ten gearwheels for forward driving is used for more than one forward speed.

10. The gearboxes defined in claim 1 for seven-speed, eight-speed and nine speed transmission gearboxes using nine gearwheels for forward driving, wherein each of nine gearwheels for forward driving is used for more than one forward speed.

11. The gearboxes defined in claim 1 for seven-speed, eight-speed and nine speed transmission gearboxes using ten gearwheels for forward driving, wherein each of ten gearwheels for forward driving is used for more than one forward speed.
